(19) United States
(12) Patent Application Publication
(10) Pub. No.: US 2019/0136003 A1
(43) Pub. Date: May 9, 2019

(54) EXTRUDED STYRENE RESIN FOAM AND PROCESS FOR PRODUCING SAME

(71) Applicant: KANEKA CORPORATION, Osaka (JP)

(72) Inventors: Takenori Kikuchi, Osaka (JP); Shunji Kurihara, Osaka (JP); Koji Shimizu, Osaka (JP)

(73) Assignee: KANEKA CORPORATION, Osaka (JP)

(21) Appl. No.: 16/103,980

(22) Filed: Aug. 16, 2018

Related U.S. Application Data
(63) Continuation of application No. PCT/JP2017/005239, filed on Feb. 14, 2017.

(30) Foreign Application Priority Data
Feb. 16, 2016 (JP) 2016-027332

(51) Int. Cl. C08J 9/00; C08J 9/14; C08J 3/22; C08K 3/04; C08K 3/22; C08K 5/136; C08K 13/02

(52) U.S. Cl. CPC C08J 9/0095; C08K 2003/2241; C08J 9/0023; C08J 9/149; C08J 3/226; C08K 3/04; C08K 3/22; C08K 5/136; C08K 13/02; C08J 2325/06; C08J 2203/202; C08J 2203/162; C08J 2203/14; C08J 2203/12; C08J 2203/142; C08J 2205/052; C08J 9/0066

(57) ABSTRACT

An extruded styrenic resin foam may include 100 parts by weight of a styrenic resin; 0.5 to 8.0 parts by weight of a flame retardant; 1.0 to 5.0 parts by weight of graphite; a saturated hydrocarbon having 3 to 5 carbon atoms; and a hydrofluoroolefin. 1 kg of the extruded styrenic resin foam includes the hydrofluoroolefin in an amount of 0.05 to 0.40 mol, and the saturated hydrocarbon in an amount of 0.10 to 0.40 mol, a total amount of the saturated hydrocarbon and the hydrofluoroolefin being 0.30 to 0.50 mol relative to 1 kg of the extruded styrenic resin foam.

### TECHNICAL FIELD

One or more embodiments of the present invention relate to an extruded styrenic resin foam which is obtained by extrusion foaming with use of a styrenic resin and a foaming agent. One or more embodiments of the present invention further relate to a method for producing such an extruded styrenic resin foam.

### BACKGROUND

In general, an extruded styrenic resin foam is continuously produced by (i) heating a styrenic resin composition with use of an extruder or the like so that the styrenic resin composition is melted, (ii) adding a foaming agent to a molten styrenic resin composition under a high pressure condition, (iii) cooling a resultant mixture to a given resin temperature, and then (iv) extruding the mixture to a low pressure region.

An extruded styrenic resin foam is used as, for example, a heat insulating material for a structure, because the extruded styrenic resin foam is good in workability and heat insulating property. In recent years, there has been an increasing demand for energy conservation in houses, buildings, and the like. Under the circumstances, technical development of a foam that is higher in heat insulating property than a conventional foam has been desired.

As a method for producing a highly heat insulating foam, the following methods have been suggested: a method in which a cell diameter of an extruded foam is controlled to fall within a given range (for example, Patent Literature 1); a method in which a heat ray radiation inhibitor is used (for example, Patent Literatures 2 and 3); and a method in which a foaming agent having a low thermal conductivity is used (for example, Patent Literatures 4 through 6).

Patent Literatures 4 through 6 suggest, as a method for using a foaming agent having a low thermal conductivity, a method for producing an extruded styrenic resin foam, in which an environmentally friendly fluorinated olefin whose ozone depleting potential is 0 (zero) and whose global warming potential is also low is used. Fluorinated olefin is also referred to as hydrofluoroolefin (HFO).

### CITATION LIST

### Patent Literature

[Patent Literature 1]
Japanese Patent Application Publication, Tokukai, No. 2004-59595

[Patent Literature 2]
Japanese Patent Application Publication, Tokukai, No. 2013-221110

[Patent Literature 3]
Japanese Patent Application Publication, Tokukai, No. 2015-113416

[Patent Literature 4]
Published Japanese Translation of PCT International Application, Tokuhyo, No. 2008-546892

[Patent Literature 5]
PCT International Publication, No. WO2015/093195

[Patent Literature 6]
Japanese Patent Application Publication, Tokukai, No. 2013-194101

However, the techniques disclosed in Patent Literatures 1 through 7 are not sufficient in terms of obtainment of an extruded styrenic resin foam which has an excellent heat insulating property and flame retardancy, a beautiful appearance, and a sufficient thickness suitable for use.

### SUMMARY

One or more embodiments of the present invention relate to an extruded styrenic resin foam which has an excellent heat insulating property and flame retardancy, a beautiful appearance, and a sufficient thickness suitable for use.

The inventors conducted a diligent study and, as a result, completed one or more embodiments of the present invention.

In other words, one or more embodiments of the present invention may have the following features.

An extruded styrenic resin foam containing: a styrenic resin; a flame retardant contained in an amount of 0.5 parts by weight to 8.0 parts by weight relative to 100 parts by weight of the styrenic resin; graphite contained in an amount of 1.0 parts by weight to 5.0 parts by weight relative to 100 parts by weight of the styrenic resin; a saturated hydrocarbon having 3 to 5 carbon atoms and serving as a foaming agent; and a hydrofluoroolefin serving as a foaming agent, (I) the hydrofluoroolefin in the extruded styrenic resin foam being contained in an amount of 0.05 mol to 0.40 mol relative to 1 kg of the extruded styrenic resin foam, (II) the saturated hydrocarbon having 3 to 5 carbon atoms in the extruded styrenic resin foam being contained in an amount of 0.10 mol to 0.40 mol relative to 1 kg of the extruded styrenic resin foam, and (III) a total amount of the amount of the saturated hydrocarbon having 3 to 5 carbon atoms and the amount of the hydrofluoroolefin, which are contained in the extruded styrenic resin foam, being 0.30 mol to 0.50 mol relative to 1 kg of the extruded styrenic resin foam.

According to one or more embodiments of the present invention, it is possible to easily obtain an extruded styrenic resin foam which has an excellent heat insulating property and flame retardancy, a beautiful appearance, and a sufficient thickness suitable for use.

### DETAILED DESCRIPTION OF THE EMBODIMENTS

The following description will discuss one or more embodiments of the present invention. However, the present invention is not limited to the embodiments discussed. The present invention is not limited to arrangements described below and may be altered in various ways by a skilled person within the scope of the claims. Any embodiment and/or an example derived from a proper combination of technical means disclosed in different embodiments and/or examples are/is also encompassed in the technical scope of the present invention. Furthermore, a new technical feature can be formed by combining technical means disclosed in differing embodiments. All academic and patent literatures listed herein are incorporated herein by reference. Unless otherwise specified herein, a numerical range expressed as “A to B” means “not less than A (equal to or more than A) and not more than B (equal to or less than B)”.

The inventors have studied the hydrofluoroolefin used in each of Patent Literatures 4 through 6 described above and found the following points.

(1) The hydrofluoroolefin has low solubility in a styrenic resin. This causes, during extrusion foaming, the hydrofluoroolefin to be separated quickly from the styrenic resin. Therefore, the hydrofluoroolefin, which has been separated, becomes a nucleating point, so that a cell diameter becomes fine. This causes a distance between cell walls of an extruded foam to be short. Accordingly, a range of movement of the cells in the extruded foam is narrow while the shape is being imparted to the extruded foam in the extrusion foaming, and it consequently becomes difficult to deform the cells. This makes it no longer easy to (i) impart a beautiful surface to the extruded foam and (ii) increase the thickness of the extruded foam.

(2) The resin is cooled and solidified (i.e., is made to no longer stretch well) due to latent heat of vaporization of the hydrofluoroolefin. This causes poor stretching of the resin itself. As a result, it becomes more unfeasible to (i) impart a beautiful surface to the extruded foam and (ii) increase the thickness of the extruded foam.

Furthermore, Patent Literature 6 suggests a method for producing an extruded styrenic resin foam having an excellent heat insulating property and excellent moldability, by using a hydrofluoroolefin and a saturated hydrocarbon in combination with water and/or carbon dioxide. However, with the range of blending amounts of foaming agent according to this conventional technology, the amount of foaming agent used is large. In a case where, in particular, graphite is used as a heat ray radiation inhibitor, it is impossible to impart suitable flame retardancy to an extruded foam. A hydrofluoroolefin is not completely incombustible. It is therefore necessary to select a suitable range of amounts of hydrofluoroolefin to be blended in view of (i) a combination of the hydrofluoroolefin and a foaming agent when these are used together, (ii) an amount of the foaming agent to be used in combination with the hydrofluoroolefin, or (iii) a combination of the hydrofluoroolefin and a heat ray radiation inhibitor when these are used together. In a case where a suitable range is not selected, a flame retardancy of a resultant extruded styrenic resin foam unfortunately deteriorates.

As has been described, according to the conventional techniques each for producing a highly heat insulating foam, (i) cells in an extruded foam are prevented from being deformed during molding and processing of the extruded foam by extrusion foaming and/or (ii) a resin itself is poor in stretch. As a result, it may be difficult to impart a beautiful surface to the extruded foam and with increasing a thickness of the extruded foam. Therefore, the conventional techniques, each for producing a highly heat insulating foam, have not yet reached a point where an extruded styrenic resin foam which has an excellent heat insulating property and flame retardancy, a beautiful appearance, and/or a sufficient thickness is easily obtained.

One or more embodiments of the present invention will be described below.

[1. Extruded Styrenic Resin Foam]

An extruded styrenic resin foam in accordance with one or more embodiments of the present invention contains (i) a styrenic resin, (ii) a flame retardant contained in an amount of 0.5 parts by weight to 8.0 parts by weight relative to 100 parts by weight of the styrenic resin, (iii) graphite contained in an amount of 1.0 parts by weight to 5.0 parts by weight relative to 100 parts by weight of the styrenic resin, (iv) a saturated hydrocarbon having 3 to 5 carbon atoms and serving as a foaming agent, (v) and a hydrofluoroolefin serving as a foaming agent. A styrenic resin composition which further contains, as necessary, another additive in an appropriate amount is heated with use of an extruder or the like so that the styrenic resin composition is melted, that is, a molten resin is obtained. Next, a foaming agent is added to the molten resin under a high pressure condition, and the molten resin to which the foaming agent is added is cooled to a given resin temperature. Thereafter, the molten resin which contains the foaming agent is extruded to a low pressure region. In this way, the extruded styrenic resin foam is continuously produced.

(1-1. Components)

(1-1-1. Styrenic Resin)

The styrenic resin used in an embodiment of the present invention is not limited to any particular one. Examples of the styrenic resin encompass: (i) homopolymers each formed from a styrene monomer, such as styrene, methylstyrene, ethylstyrene, isopropyl styrene, dimethylstyrene, bromostyrene, chlorostyrene, vinyltoluene, or vinyl xylene, and copolymers each formed from a combination of two or more of such styrene monomers; and (ii) copolymers each formed through copolymerization of (a) such a styrene monomer and (b) one or more of monomers such as divinylbenzene, butadiene, acrylic acid, methacrylic acid, methyl acrylate, methyl methacrylate, acrylonitrile, maleic anhydride, and itaconic anhydride. Note that it is possible to use a monomer(s), such as acrylic acid, methacrylic acid, methyl acrylate, methyl methacrylate, maleic anhydride, and/or itaconic anhydride, which is/are copolymerized with a styrene monomer, in an amount(s) that does/do not decrease physical properties, such as compressive strength, of the extruded styrenic resin foam to be produced. Note also that the styrenic resin used in an embodiment of the present invention is not limited to the above homopolymers and copolymers. Alternatively, the styrenic resin can be a styrenic resin obtained by blending any of (i) a homopolymer formed from a styrene monomer, (ii) a copolymer formed from two or more kinds of styrene monomers, (iii) a homopolymer formed from a monomer other than a styrene monomer, and (iv) a copolymer formed from a styrene monomer and one or more kinds of monomer(s) other than a styrene monomer. For example, the styrenic resin used in an embodiment of the present invention can be a styrenic resin obtained by blending (i) a homopolymer or a copolymer each formed from a styrene monomer(s) and (ii) diene rubber-reinforced polystyrene or acrylic rubber-reinforced polystyrene. Note also that the styrenic resin used in an embodiment of the present invention can be a styrenic resin having a branched structure, for the adjustment of a melt flow rate (hereinafter, referred to as an MFR), a melt viscosity during molding, a melt tension during the molding, and the like.

The styrenic resin used in one or more embodiments of the present invention preferably has a MFR of 0.1 g/10 minutes to 50 g/10 minutes, because such a styrenic resin brings about the following five advantages: (1) the moldability during the extrusion foaming molding is excellent; (2) it is easy to adjust, to a desired quantity, a discharge quantity during the molding, and it is easy to adjust, to respective desired values, the thickness, a width, an apparent density, and a closed cell ratio of the extruded styrenic resin foam to be obtained; (3) foamability is excellent (it is easy to adjust, to desired values or a desired property, the thickness, the width, the apparent density, the closed cell ratio, a surface property, and the like of the foam); (4) the extruded styrenic resin foam which is excellent in appearance and the like is obtained; and (5) the extruded styrenic resin foam which is balanced in terms of characteristics (for example, mechanical strength or toughness, such as compressive strength, bending strength, or an amount of bending deflection) is obtained. In view of balance between (i) the moldability and the foamability and (ii) the mechanical strength and the toughness, the styrenic resin has a MFR of more preferably 0.3 g/10 minutes to 30 g/10 minutes, and particularly preferably 0.5 g/10 minutes to 25 g/10 minutes. In one or more embodiments of the present invention, the MFR is measured by the method A under the test condition H as specified in JIS K7210 (1999).

In one or more embodiments of the present invention, of the foregoing styrenic resins, a polystyrene resin is particularly suitable in view of cost effectiveness and processability. In a case where the extruded foam is required to have higher heat resistance, it is preferable to use a styrene-acrylonitrile copolymer, (meth)acrylate copolymerized polystyrene, and/or maleic anhydride modified polystyrene. In a case where the extruded foam is required to have higher impact resistance, it is preferable to use rubber-reinforced polystyrene. Each of these styrenic resins can be used solely. Alternatively, two or more of these styrenic resins, which are different in copolymer component, molecular weight, molecular weight distribution, branched structure, MFR, and/or like, can be used in combination.

(1-1-2. Foaming Agent)

Examples of the saturated hydrocarbon having 3 to 5 carbon atoms used in one or more embodiments of the present invention encompass propane, n-butane, i-butane, n-pentane, i-pentane, and neopentane. In one or more embodiments, propane, n-butane, i-butane, or a mixture thereof is preferable in view of the foamability. In view of the heat insulating property of the foam, n-butane, i-butane (hereinafter, also referred to as “isobutane”), or a mixture thereof is preferable, and i-butane is particularly preferable.

The hydrofluoroolefin of one or more embodiments of the present invention are not limited in particular. However, a tetrafluoropropene is preferable because the tetrafluoropropene has a low thermal conductivity in a gaseous state and is safe. Specific examples of the tetrafluoropropene encompass trans-1,3,3,3-tetrafluoropropene (trans-HFO-1234ze), cis-1,3,3,3-tetrafluoropropene (cis-HFO-1234ze), and 2,3,3,3-tetrafluoropropene (trans-HFO-1234yf). Each of these hydrofluoroolefins can be used solely. Alternatively, two or more of these hydrofluoroolefins can be used in combination.

The amount and/or the like of the saturated hydrocarbon having 3 to 5 carbon atoms and/or the hydrofluoroolefin to be added may be limited depending on various intended characteristics, such as a foaming ratio and the flame retardancy, of the foam. In a case where the amount is outside a desired range as a result of being limited for the reason described above, the moldability of the extruded foam or the like may not be sufficient.

In one or more embodiments of the present invention, another foaming agent is further used. This makes it possible to bring about the plasticizing effect and/or an auxiliary foaming effect during the production of the foam. This ultimately allows a reduction in extrusion pressure and allows the foam to be stably produced.

Examples of the another foaming agent encompass (i) organic foaming agents such as: ethers such as dimethyl ether, diethyl ether, methyl ethyl ether, isopropyl ether, n-butyl ether, diisopropyl ether, furan, furfural, 2-methylfuran, tetrahydrofuran, and tetrahydropyran; ketones such as dimethyl ketone, methyl ethyl ketone, diethyl ketone, methyl-n-propyl ketone, methyl-n-butyl ketone, methyl-i-butyl ketone, methyl-n-amyl ketone, methyl-n-hexyl ketone, ethyl-n-propyl ketone, and ethyl-n-butyl ketone; saturated alcohols each having 1 to 4 carbon atom(s), such as methanol, ethanol, propyl alcohol, i-propyl alcohol, butyl alcohol, i-butyl alcohol, and t-butyl alcohol; carboxylic acid esters such as methyl formate, ethyl formate, propyl formate, butyl formate, amyl formate, methyl propionate, and ethyl propionate; and alkyl halides such as methyl chloride and ethyl chloride, (ii) inorganic foaming agents such as water and carbon dioxide, and (iii) chemical foaming agents such as an azo compound and tetrazole. Each of these foaming agents can be used solely as another foaming agent. Alternatively, two or more of these foaming agents can be used in combination as another foaming agent.

In one or more embodiments, a saturated alcohol having 1 to 4 carbon atom(s), dimethyl ether, diethyl ether, methyl ethyl ether, methyl chloride, ethyl chloride, or the like is preferable, in view of the foamability during production of an extruded foam, the moldability of the foam, and the like. In view of the flame retardancy or the heat insulating property of the foam, and the like, water or carbon dioxide is preferable. In one or more embodiments, dimethyl ether, methyl chloride, or ethyl chloride is particularly preferable in view of the plasticizing effect, and water is particularly preferable in view of a cost and the heat insulating property enhancing effect brought about by control of a cell diameter.

In one or more embodiments of the present invention, in a case where dimethyl ether, methyl chloride, or ethyl chloride is used as another foaming agent, such another foaming agent is to be added in an amount of preferably 0.5 parts by weight to 15 parts by weight, more preferably 1.0 parts by weight to 10 parts by weight, and particularly preferably 2.0 parts by weight to 8.0 parts by weight, relative to 100 parts by weight of the styrenic resin. In a case where the amount of dimethyl ether, methyl chloride, or ethyl chloride to be added is less than 0.5 parts by weight relative to 100 parts by weight of the styrenic resin, the amount is excessively small. This makes it difficult to achieve enhancement of (i) foamability of an extruded foam and (ii) moldability of a foam. In a case where dimethyl ether, methyl chloride, or ethyl chloride is added in an amount more than 15 parts by weight relative to 100 parts by weight of the styrenic resin, an excessively large amount of such a foaming agent remains in a resulting extruded foam. This may pose a risk of impairing flame retardancy.

In one or more embodiments of the present invention, the foaming agent is added in an amount of preferably 2.0 parts by weight to 20 parts by weight, and more preferably 2.0 parts by weight to 15 parts by weight, in total, relative to 100 parts by weight of the styrenic resin. In a case where the amount of the foaming agent is less than 2.0 parts by weight, the foaming ratio is low and, accordingly, the resin foam may not have characteristics such as a lightweight property and the heat insulating property. In a case where the amount of the foaming agent is more than 20 parts by weight, a defect such as a void may occur in the foam because the amount of the foaming agent is excessively large.

In one or more embodiments of the present invention, a saturated hydrocarbon having 3 to 5 carbon atoms and a hydrofluoroolefin are contained as foaming agents and,

(I) the hydrofluoroolefin in the extruded styrenic resin foam being contained in an amount of 0.05 mol to 0.40 mol relative to 1 kg of the extruded styrenic resin foam,

(II) the saturated hydrocarbon having 3 to 5 carbon atoms in the extruded styrenic resin foam being contained in an amount of 0.10 mol to 0.40 mol relative to 1 kg of the extruded styrenic resin foam, and

(III) a total amount of the amount of the saturated hydrocarbon having 3 to 5 carbon atoms and the amount of the hydrofluoroolefin, which are contained in the extruded styrenic resin foam, being 0.30 mol to 0.50 mol relative to 1 kg of the extruded styrenic resin foam.

The terms “amount of . . . contained”, “contained in an amount of”, and “ . . . content” used herein for an amount contained in an extruded styrenic resin foam each refer to an amount contained in an extruded styrenic resin foam which has been subjected to extrusion foaming, that is, an extruded styrenic resin foam which has been produced. Meanwhile, an amount of each material used during production of an extruded styrenic resin foam is herein described as “amount of . . . (to be) added”, “added in an amount of”, “amount of . . . (to be) blended”, and “blended in an amount of”, and are thus distinguished from “amount of . . . contained”, “contained in an amount of”, and “ . . . content”. The terms “amount of . . . (to be) added” and “added in an amount of” can be used interchangeably with “amount of . . . (to be) blended” and “blended in an amount of”. It can be said that an amount of any given component “contained” in one or more embodiments of the present invention is, out of an amount of the component “added” during production of an extruded styrenic resin foam, an amount of the component remaining in the extruded styrenic resin foam which has been produced. Therefore, it can be said that “amount of . . . (to be) contained” is “amount of . . . remaining”.

In one or more embodiments of the present invention, a saturated hydrocarbon having 3 to 5 carbon atoms is contained in the extruded styrenic resin foam in an amount of 0.10 mol to 0.40 mol, preferably 0.15 mol to 0.35 mol, and more preferably 0.15 mol to 0.30 mol, relative to 1 kg of the extruded foam. In a case where the saturated hydrocarbon having 3 to 5 carbon atoms is contained in the extruded styrenic resin foam in an amount less than 0.10 mol relative to 1 kg of the extruded foam, the amount of the saturated hydrocarbon having 3 to 5 carbon atoms in the foam is excessively small. This makes it impossible to achieve a desired heat insulating property. In a case where the saturated hydrocarbon having 3 to 5 carbon atoms is contained in the extruded styrenic resin foam in an amount more than 0.40 mol relative to 1 kg of the extruded foam, the amount of the saturated hydrocarbon (which is a flammable gas) having 3 to 5 carbon atoms in the foam is excessively large. This makes it impossible to achieve a desired flame retardancy.

In one or more embodiments of the present invention, a hydrofluoroolefin is contained in the extruded styrenic resin foam in an amount of 0.05 mol to 0.40 mol, preferably 0.10 mol to 0.35 mol, and more preferably 0.10 mol to 0.30 mol, relative to 1 kg of the extruded foam. In a case where the hydrofluoroolefin is contained in the extruded styrenic resin foam in an amount less than 0.05 mol relative to 1 kg of the extruded foam, the amount of the hydrofluoroolefin in the foam is excessively small. This makes it impossible to achieve a desired heat insulating property. In a case where the hydrofluoroolefin is contained in the extruded styrenic resin foam in an amount more than 0.40 mol relative to 1 kg of the extruded foam, the amount of the hydrofluoroolefin in the foam is excessively large. This impairs moldability, and therefore makes it impossible to achieve an extruded foam having a desired appearance.

Ozone layer depleting potential of the hydrofluoroolefin is zero or extremely low. Furthermore, global warming potential of the hydrofluoroolefin is very low. Therefore, the hydrofluoroolefin is an environmentally friendly foaming agent. Moreover, the hydrofluoroolefin has a low thermal conductivity in a gaseous state, and has flame retardancy (it is, however, not completely incombustible). Therefore, by using the hydrofluoroolefin as the foaming agent of the extruded styrenic resin foam, it is possible to bring about the following two advantages: (1) it is possible to impart an excellent heat insulating property to the extruded styrenic resin foam, and (2) it is easy to impart, to the extruded styrenic resin foam, a flame retardancy which is more excellent than in a case where a conventional flammable gas is used.

In a case where the hydrofluoroolefin, such as the tetrafluoropropene, which has low solubility in the styrenic resin is used, it tends to be difficult to impart a beautiful surface to an extruded foam and to cause the extruded foam to be thick. This is because the hydrofluoroolefin is separated from the molten resin and vaporizes as the amount of the hydrofluoroolefin added is increased, so that the hydrofluoroolefin, which has consequently become a nucleating point, causes the following three phenomena to occur: (1) cells in the foam become fine, (2) the plasticizing effect on the molten resin decreases due to a decrease in an amount of the foaming agent remaining in the resin, and (3) the molten resin becomes cooled and solidified due to latent heat of vaporization of the foaming agent.

In one or more embodiments of the present invention, a total amount of the amount of the saturated hydrocarbon having 3 to 5 carbon atoms and the amount of the hydrofluoroolefin, which are contained in the extruded styrenic resin foam, is 0.30 mol to 0.50 mol, preferably 0.35 mol to 0.50 mol, and more preferably 0.40 mol to 0.50 mol, relative to 1 kg of the extruded foam. In a case where the total amount is less than 0.30 mol, the amount of the foaming agent in the foam is excessively small. This makes it impossible to achieve a desired heat insulating property. A saturated hydrocarbon having 3 to 5 carbon atoms is a flammable gas. Meanwhile, although a hydrofluoroolefin has flame retardancy, the hydrofluoroolefin is not completely incombustible. Therefore, in a case where the total amount is more than 0.50 mol, the amount of the foaming agents (the saturated hydrocarbon having 3 to 5 carbon atoms and the hydrofluoroolefin) contained in the extruded foam is excessively large. This causes a combustion spreading length in the JIS combustion test to be such a great length as more than 10 mm.

The restriction of gas surface combustion of a foam cannot be achieved only by an increase in a flame retardant. Note that the term “gas surface combustion” herein means combustion of gas at a surface of a foam. The mechanism of gas surface combustion will be described below but is not limited to a mechanism described below. The mechanism is assumed as follows: When a fire source ignites a foam, destruction of a cell occurs, which destruction causes a foaming agent (flammable gas) present in a cell structure to be released into an atmosphere, so that combustion of the gas with oxygen in the air occurs at a surface of the foam. Therefore, it is assumed that if a foam has a structure vulnerable to heat, then gas in the foam is easily released, so that combustion of the gas at a surface of the foam ends up being promoted. Furthermore, in a case of a foam containing a heat ray radiation inhibitor, such as graphite used in one or more embodiments of the present invention, which has an effect of absorbing heat ray radiation for achieving an excellent heat insulating property, such a foam conventionally allows gas surface combustion to occur more easily than is the case of a foam which contains no heat ray radiation inhibitor. This is possibly because a heat ray radiation inhibitor absorbs radiation of a flame during the combustion and therefore causes a foam to have a high temperature which leads the foam to collapse, so that a large amount of foaming agent is consequently released from the inside of the foam. Combustion of gas typically occurs only at a surface layer portion of a JIS combustion test piece, and combustion of a fire source may spread to an uppermost part instantly.

According to one or more embodiments of the present invention, the extruded styrenic resin foam contains a saturated hydrocarbon having 3 to 5 carbon atoms and a hydrofluoroolefin in respective amounts in desired ranges and in a total amount in a desired range. This brings about the following two advantages: (i) it is possible to impart an excellent heat insulating property to a foam; and (ii) it is possible control spreading of combustion, which occurs at a surface of a foam due to gas, to be restricted, so that it is possible to control combustion spreading length to not more than 10 mm.

With one or more embodiments of the present invention, an extruded styrenic resin foam having an excellent heat insulating property and flame retardancy can be achieved by satisfying the following (1) and (2): (1) an extruded styrenic resin foam contains a saturated hydrocarbon having 3 to 5 carbon atoms and a hydrofluoroolefin to be contained in respective amounts in desired ranges and in a total amount in a desired range; and (2) the extruded styrenic resin foam contains at least one selected from the group consisting of dimethyl ether, ethyl chloride, and methyl chloride. This is because, by satisfying (1) and (2) above, it is possible to improve a shape, a surface property, and a thickness increasing property of an extruded foam, which deteriorate in a case where hydrofluoroolefin is used as a foaming agent. Note that a shape, a surface property, and a thickness increasing property of an extruded foam may be herein referred to as “extruded foam moldability”. In a case where a large amount of hydrofluoroolefin is to be used for enhancing a heat insulating property, an extruded foam moldability deteriorates. Therefore, in one or more embodiments, it is preferable to satisfy the following (1) through (3): (1) a hydrofluoroolefin content is restricted to an amount falling within the desired ranges above; (2) a saturated hydrocarbon having 3 to 5 carbon atoms is contained; and (3) at least one selected from the group consisting of dimethyl ether, ethyl chloride, and methyl chloride is contained. By satisfying (1) through (3) above, it is possible to secure good moldability of an extruded foam. Meanwhile, in a case where only hydrofluoroolefin is used as a foaming agent and is contained in an amount within the above desired range, an amount of a foaming agent contained in an extruded foam is excessively small. This prevents a heat insulating property from increasing much. Therefore, in one or more embodiments, it is preferable to cause the foam to contain a saturated hydrocarbon having 3 to 5 carbon atoms in an amount which does not impair flame retardancy, that is, in the amount described above. In a case where a hydrofluoroolefin and a saturated hydrocarbon having 3 to 5 carbon atoms are contained in the amounts described above, moldability is insufficient (i.e., poor) although a good heat insulating property and flame retardancy can be secured. Therefore, in one or more embodiments, it is preferable that at least one selected from the group consisting of dimethyl ether, ethyl chloride, and methyl chloride is contained as a foaming agent which does not affect flame retardancy much and has a large effect on enhancement of foamability and moldability of an extruded foam. It is possible to impart an excellent heat insulating property and a suitable flame retardancy to an extruded foam and cause the extruded foam to have a desired foam structure by (i) causing the extruded foam to contain, in the amounts described above, a hydrofluoroolefin and a saturated hydrocarbon having 3 to 5 carbon atoms and (ii) causing the extruded foam to contain at least one selected from the group consisting of dimethyl ether, ethyl chloride, and methyl chloride.

In order for a saturated hydrocarbon having 3 to 5 carbon atoms and a hydrofluoroolefin to be contained in an extruded styrenic resin foam in amounts controlled to fall within desired ranges defined in one or more embodiments of the present invention, the following (1) through (3), for example, need to be adjusted: (1) amounts of the saturated hydrocarbon having 3 to 5 carbon atoms and the hydrofluoroolefin blended; (2) an extrusion temperature; and (3) foaming pressure. To control the amounts of the saturated hydrocarbon having 3 to 5 carbon atoms and the hydrofluoroolefin contained means, in other words, to control remaining amounts of the saturated hydrocarbon having 3 to 5 carbon atoms and the hydrofluoroolefin. In order for the remaining amounts of the saturated hydrocarbon having 3 to 5 carbon atoms and the hydrofluoroolefin to be controlled, the above (2) extrusion temperature and the above (3) foaming pressure are specifically adjusted as follows. In a case where the remaining amounts of the saturated hydrocarbon having 3 to 5 carbon atoms and the hydrofluoroolefin are to be increased, the following are carried out during extrusion foaming: (i) the above (2) extrusion temperature is to be maintained at a low temperature; and (ii) the above (3) expansion pressure is maintained at a high pressure. In contrast, in a case where the remaining amounts of the saturated hydrocarbon having 3 to 5 carbon atoms and the hydrofluoroolefin are to be decreased, the following are carried out during extrusion foaming: (i) the above (2) extrusion temperature is to be maintained at a high temperature; and (ii) the above (3) expansion pressure is maintained at a low pressure.

In some cases, amounts of saturated hydrocarbon having 3 to 5 carbon atoms and hydrofluoroolefin contained in an extruded styrenic resin foam start gradually decreasing immediately after the extruded styrenic resin foam is produced. This is presumably because the saturated hydrocarbon having 3 to 5 carbon atoms and the hydrofluoroolefin gradually disappear from, in particular, a surface of the extruded styrenic resin foam immediately after the production. However, such disappearance is a phenomenon that occurs immediately after the production, and hardly occurs after 7 days passed since the production. In other words, after 7 days passed since the production, the amounts of the saturated hydrocarbon having 3 to 5 carbon atoms and the hydrofluoroolefin contained in the extruded styrenic resin foam can be deemed substantially constant. Therefore, in one or more embodiments of the present invention, amounts of a saturated hydrocarbon having 3 to 5 carbon atoms and a hydrofluoroolefin contained in an extruded styrenic resin foam can be the amounts after 7 days passed since the production of the extruded styrenic resin foam.

In one or more embodiments of the present invention, in a case where water is used as a foaming agent, a water absorbing substance is preferably added so that the extrusion foaming molding is stably carried out. Specific examples of the water absorbing substance used in one or more embodiments of the present invention encompass: water absorbing polymers such as a polyacrylate polymer, a starch-acrylic acid graft copolymer, a polyvinyl alcohol polymer, a vinyl alcohol-acrylate copolymer, an ethylene-vinyl alcohol copolymer, an acrylonitrile-methyl methacrylate-butadiene copolymer, a polyethylene oxide copolymer, and derivatives thereof; fine powders each having a hydroxyl group on a surface thereof and having a particle diameter of not more than 1000 nm, such as anhydrous silica (silicon oxide) having a silanol group on a surface thereof [AEROSIL, manufactured by Nippon AEROSIL CO., LTD, is, for example, commercially available]; water absorbing or water swelling layer silicates, such as smectite and water swelling fluorine mica, and products obtained by organification of such water absorbing or water swelling layer silicates; and porous substances such as zeolite, activated carbon, alumina, silica gel, porous glass, activated clay, diatomaceous earth, and bentonite. In one or more embodiments, an amount of the water absorbing substance to be added is adjusted as appropriate depending on the amount and/or the like of the water to be added but is preferably 0.01 parts by weight to 5 parts by weight, and is more preferably 0.1 parts by weight to 3 parts by weight, relative to 100 parts by weight of the styrenic resin.

In a method for producing an extruded styrenic resin foam in accordance with one or more embodiments of the present invention, a pressure at which the foaming agent is added or injected is not limited in particular. The pressure only needs to be higher than an internal pressure of the extruder or the like.

(1-1-3. Flame Retardant)

In one or more embodiments of the present invention, it is possible to impart the flame retardancy to the extruded styrenic resin foam, by causing the extruded styrenic resin foam to contain a flame retardant in an amount of 0.5 parts by weight to 8.0 parts by weight relative to 100 parts by weight of the styrenic resin. In a case where the amount of the flame retardant contained is less than 0.5 parts by weight, it tends to be difficult for the extruded styrenic resin foam to achieve good characteristics such as the flame retardancy. In a case where the amount of the flame retardant is more than 8.0 parts by weight, the stability during the production of the foam, the surface property, or the like may be impaired. In one or more embodiments, however, the amount of the flame retardant contained is more preferably adjusted as appropriate, depending on the amount of the foaming agent added or contained, the apparent density of the foam, a type or an amount of, for example, a contained additive having a flame retardancy synergistic effect, and the like, so that, in a case where the flame retardancy is measured by the measurement method A specified in JIS A9521, the flame retardancy matches flame retardancy specified in JIS A9521.

According to the extruded styrenic resin foam in accordance with one or more embodiments of the present invention preferably (i) has passed the measurement method A specified in JIS A9521 for a flammability; and (ii) has a combustion spreading length of not more than 10 mm.

According to the extruded styrenic resin foam in accordance with one or more embodiments of the present invention, the flame retardant is preferably a bromine flame retardant. In one or more embodiments of the present invention, specific examples of the bromine flame retardant encompass aliphatic bromine containing polymers such as hexabromocyclododecane, tetrabromobisphenol A-bis(2,3-dibromo-2-methylpropyl)ether, tetrabromobisphenol A-bis(2,3-dibromopropyl)ether, tris(2,3-dibromopropyl)isocyanurate, and a brominated styrene-butadiene block copolymer. Each of these bromine flame retardants can be used solely. Alternatively, two or more of these bromine flame retardants can be used in combination.

In one or more embodiments, any of the following three is preferably used: (i) a mixed bromine flame retardant made up of tetrabromobisphenol A-bis(2,3-dibromo-2-methylpropyl)ether and tetrabromobisphenol A-bis(2,3-dibromopropyl)ether, (ii) the brominated styrene-butadiene block copolymer, and (iii) hexabromocyclododecane. This is because such bromine flame retardants, for example, (i) allow extrusion operation to be favorably carried out and (ii) do not adversely affect the heat resistance of the foam. Each of these substances can be used solely. Alternatively, some of these substances can be used as a mixture.

The extruded styrenic resin foam in accordance with one or more embodiments of the present invention contains the bromine flame retardant in an amount of preferably 0.5 parts by weight to 5.0 parts by weight, more preferably 1.0 parts by weight to 5.0 parts by weight, and still more preferably 1.5 parts by weight to 5.0 parts by weight, relative to 100 parts by weight of the styrenic resin. In a case where the amount of the bromine flame retardant contained is less than 0.5 parts by weight, it tends to be difficult for the extruded styrenic resin foam to achieve good characteristics such as the flame retardancy. In a case where the amount of the bromine flame retardant contained is more than 5.0 parts by weight, the stability during the production of the foam, the surface property, or the like may be impaired.

In one or more embodiments of the present invention, it is possible to use, in combination with the flame retardant, a radical generating agent for the enhancement of the flame retardancy of the extruded styrenic resin foam. Specific examples of the radical generating agent encompass 2,3-dimethyl-2,3-diphenylbutane, poly-1,4-diisopropylbenzene, 2,3-diethyl-2,3-diphenylbutane, 3,4-dimethyl-3,4-diphenylhexane, 3,4-diethyl-3,4-diphenylhexane, 2,4-diphenyl-4-methyl-1-pentene, and 2,4-diphenyl-4-ethyl-1-pentene. A peroxide such as dicumyl peroxide can be also used. In one or more embodiments, a radical generating agent is preferable which is stable at a temperature at which the resin is processed. Specifically, 2,3-dimethyl-2,3-diphenylbutane and poly-1,4-diisopropylbenzene are preferable. The radical generating agent is added in an amount of preferably 0.05 parts by weight to 0.5 parts by weight relative to 100 parts by weight of the styrenic resin.

In one or more embodiments, for the enhancement of the flame retardancy, in other words, as an auxiliary flame retardant, a phosphorus flame retardant such as phosphoric ester and phosphine oxide can be used in combination with the flame retardant, provided that the phosphorus flame retardant does not impair thermal stability of the extruded styrenic resin foam. Examples of the phosphoric ester include triphenyl phosphate, tris(tributylbromoneopentyl)phosphate, tricresyl phosphate, trixylenyl phosphate, cresyl diphenyl phosphate, 2-ethylhexyl diphenyl phosphate, trimethyl phosphate, triethyl phosphate, tributyl phosphate, tris(2-ethylhexyl)phosphate, tris(butoxyethyl)phosphate, and condensed phosphoric esters. In particular, triphenyl phosphate or tris(tributylbromoneopentyl)phosphate is preferable. Of phosphine oxide type phosphorus flame retardants, triphenylphosphine oxide is preferable. Each of these phosphoric esters and phosphine oxides can be used solely. Alternatively, two or more of these phosphoric esters and phosphine oxides can be used in combination. The phosphorus flame retardant is added in an amount of preferably 0.1 parts by weight to 2 parts by weight relative to 100 parts by weight of the styrenic resin.

(1-1-4. Stabilizer)

In one or more embodiments of the present invention, a stabilizer which is a resin and/or a stabilizer which has flame retardancy can be used as necessary. Such a stabilizer is not limited in particular. Such a stabilizer is not limited in particular. Specific examples of the stabilizer encompass: (i) epoxy compounds such as a bisphenol A diglycidyl ether type epoxy resin, a cresol novolac type epoxy resin, and a phenol novolac type epoxy resin; (ii) polyhydric alcohol esters each of which (a) is a mixture of esters each having at least one hydroxyl group in its molecule and each being obtained by reacting a polyhydric alcohol (such as pentaerythritol, dipentaerythritol, or tripentaerythritol) and a monovalent carboxylic acid (such as acetic acid or propionic acid) or a divalent carboxylic acid (such as adipic acid or glutamic acid) and (b) may contain a raw material polyhydric alcohol in a small amount; (iii) phenolic stabilizers such as triethylene glycol-bis-3-(3-tert-butyl-4-hydroxy-5-methylphenyl)propionate, pentaerythritol tetrakis[3-(3′,5′-di-tert-butyl-4′-hydroxyphenyl)propionate], and octadecyl 3-(3,5-di-tert-butyl-4-hydroxyphenyl)propionate; (iv) phosphite stabilizers such as 3,9-bis(2,4-di-tert-butylphenoxy)-2,4,8,10-tetraoxa-3,9-diphospha-spiro [5.5] undecane, 3,9-bis(2,6-di-tert-butyl-4-methyl phenoxy)-2,4,8,10-tetraoxa-3,9-diphospha-spiro [5.5] undecane, and tetrakis(2,4-di-tert-butyl-5-methylphenyl)-4,4′-biphenylene diphosphonite). In one or more embodiments, these stabilizers are preferable because these stabilizers do not decrease the flame retardancy of the foam and these stabilizers enhance the thermal stability of the foam.

(1-1-5. Heat Ray Radiation Inhibitor)

The extruded styrenic resin foam in accordance with one or more embodiments of the present invention can contain graphite as a heat ray radiation inhibitor so that the heat insulating property is enhanced. Examples of the graphite used in one or more embodiments of the present invention encompass flake (scale-like) graphite, amorphous graphite, spheroidal graphite, and artificial graphite. In one or more embodiments, graphite which contains flake (scale-like) graphite as a main component is preferably used because such graphite brings about a greater heat ray radiation inhibiting effect. The graphite used in one or more embodiments of the present invention is one that contains fixed carbon at a proportion of preferably not less than 80%, and more preferably not less than 85%. The graphite which contains the fixed carbon at the above proportion allows the foam to have a high heat insulating property.

In one or more embodiments, the graphite has a dispersed particle diameter of preferably not more than 15 m, and more preferably not more than 10 m. The graphite which has a dispersed particle diameter falling within the above range has a large specific surface area, so that a probability of collision between the graphite and a heat ray radiation is increased. This ultimately causes an increase in the heat ray radiation inhibiting effect. In order for the dispersed particle diameter to fall within the above range, it is only necessary to select the graphite which has a primary particle diameter of not more than 15 m.

Note that the dispersed particle diameter indicates a number-based arithmetical mean of particle diameters of particles dispersed in a foam, and the particle diameters are measured while a cross section of the foam is magnified with use of a microscope or the like. Note that the primary particle diameter means a volume average particle diameter (d50).

In one or more embodiments of the present invention, the graphite is contained in an amount of preferably 1.0 parts by weight to 5.0 parts by weight, and more preferably 1.5 parts by weight to 3.0 parts by weight, relative to 100 parts by weight of the styrenic resin. In a case where the amount of the graphite contained is less than 1.0 part by weight, the graphite does not bring about a sufficient heat ray radiation inhibiting effect. In a case where the amount of the graphite contained is more than 5.0 parts by weight, the graphite does not bring about a heat ray radiation inhibiting effect equivalent to the amount and, therefore, there is no advantage in terms of a cost.

The heat ray radiation inhibitor indicates a substance which reflects, scatters, and absorbs light in a near infrared region or an infrared region (for example, wavelength region of approximately 800 nm to 3000 nm). The foam which contains the heat ray radiation inhibitor can have a high heat insulating property. As the heat ray radiation inhibitor which can be used in one or more embodiments of the present invention, white particles, such as titanium oxide, barium sulfate, zinc oxide, aluminum oxide, and antimony oxide, can be used in combination with the graphite. Each of these white particles can be used solely. Alternatively, two or more of these white particles can be used in combination. In one or more embodiments, titanium oxide or barium sulfate is preferable, and titanium oxide is more preferable, because such white particles bring about a greater heat ray radiation inhibiting effect. A dispersed particle diameter of the white particles is not limited in particular. For example, a dispersed particle diameter of titanium oxide is preferably 0.1 μm to 10 μm, and more preferably 0.15 μm to 5 μm, in view of effective reflection of an infrared ray and in view of coloring of the resin.

In one or more embodiments of the present invention, the white particles are contained in an amount of preferably 1.0 parts by weight to 3.0 parts by weight, and more preferably 1.5 parts by weight to 2.5 parts by weight, relative to 100 parts by weight of the styrenic resin. The white particles have a less heat ray radiation inhibiting effect than the graphite. Accordingly, in a case where the amount of the white particles contained is less than 1.0 part by weight, the white particles hardly bring about the heat ray radiation inhibiting effect even though the white particles are contained. In a case where the amount of the white particles contained is more than 3.0 parts by weight, the white particles do not bring about the heat ray radiation inhibiting effect equivalent to the amount, and, in the meanwhile, the flame retardancy of the foam tends to deteriorate.

In one or more embodiments of the present invention, the heat ray radiation inhibitor is contained in an amount of preferably 1.0 parts by weight to 6.0 parts by weight, and more preferably 2.0 parts by weight to 5.0 parts by weight, in total, relative to 100 parts by weight of the styrenic resin. In a case where the amount of the heat ray radiation inhibitor contained is less than 1.0 part by weight in total, it is difficult to achieve the heat insulating property. Meanwhile, as an amount of a contained solid additive such as the heat ray radiation inhibitor is increased, the number of nucleating points is increased, so that the cells in the foam become fine and/or the resin itself becomes poor in stretch. This tends to make it difficult to (i) impart a beautiful surface to the extruded foam and (ii) increase the thickness of the extruded foam. In particular, in a case where the amount of the heat ray radiation inhibitor contained is more than 6.0 parts by weight in total, it tends to be difficult to (i) impart a beautiful surface to the extruded foam and (ii) increase the thickness of the extruded foam. Furthermore, in such a case, extrusion stability and the flame retardancy tends to be impaired.

(1-1-6. Additive)

In one or more embodiments of the present invention, an additive can be further contained in the styrenic resin as necessary, provided that the additive does not inhibit effects in accordance with one or more embodiments of the present invention. Examples of the additive encompass: inorganic compounds such as silica, calcium silicate, wollastonite, kaolin, clay, mica, and calcium carbonate; processing aids such as sodium stearate, calcium stearate, magnesium stearate, barium stearate, liquid paraffin, olefin wax, and a stearyl amide compound; light-resistant stabilizers such as a phenolic antioxidant, a phosphorus stabilizer, a nitrogen stabilizer, a sulfuric stabilizer, benzotriazoles, and hindered amines; cell diameter adjusting agents such as talc; flame retardants other than the foregoing flame retardants; antistatic agents; coloring agents such as a pigment; and plasticizers.

Examples of a method for adding such various additives to the styrenic resin include the following methods or procedures (1) through (4): (1) a method in which the various additives are added to the styrenic resin and then the various additives and the styrenic resin are mixed together by dry blending; (2) a method in which the various additives are added to a molten styrenic resin through a feeder provided in the middle of the extruder; (3) a method in which (i) a masterbatch is prepared in advance by causing, with use of an extruder, a kneader, a Banbury mixer, a roll, or the like, the styrenic resin to contain the various additives that are highly concentrated and (ii) the masterbatch and the styrenic resin which is different from that contained in the masterbatch are mixed together by dry blending; and (4) a method in which a feeding machine different from that used for the styrenic resin is used to supply (i) the various additives or (ii) a masterbatch prepared by causing the styrenic resin to contain the various additives at a high concentration. Examples of a procedure for blending such various additives with the styrenic resin include a procedure in which (i) the various additives are added to and mixed with the styrenic resin, (ii) a resultant mixture is supplied to the extruder and heated so that the mixture is melted, and then (iii) the foaming agent is added to and mixed with the mixture. Note, however, that a timing at which the various additives or the foaming agent are/is added to the styrenic resin and a time period during which the styrenic resin is kneaded or the styrenic resin and the various additives and/or the foaming agent are kneaded are not limited in particular.

(1-2. Physical Properties)

A thermal conductivity of the extruded styrenic resin foam in accordance with one or more embodiments of the present invention is not limited in particular. In one or more embodiments, the thermal conductivity which is measured 1 week after the production at an average temperature of 23° C. is preferably not more than 0.0245 W/mK, more preferably not more than 0.0235 W/mK, and particularly preferably not more than 0.0225 W/mK. The thermal conductivity falling within the above ranges brings about such an advantage that the extruded styrenic resin foam exhibits an excellent heat insulating property in a case where the extruded styrenic resin foam serves, for example, as a heat insulating material for a building or as a heat insulating material for a cool box or a refrigerator car.

The extruded styrenic resin foam in accordance with one or more embodiments of the present invention may have an apparent density of preferably 20 kg/m³ to 45 kg/m³, and more preferably 25 kg/m³ to 40 kg/m³. The apparent density falling within the above ranges brings about such an advantage that the extruded styrenic resin foam exhibits an excellent heat insulating property and an excellent lightweight property in a case where the extruded styrenic resin foam serves, for example, as a heat insulating material for a building or as a heat insulating material for a cool box or a refrigerator car.

The extruded styrenic resin foam in accordance with one or more embodiments of the present invention may have a closed cell ratio of preferably not less than 90%, and more preferably not less than 95%. In a case where the closed cell ratio is less than 90%, the foaming agent dissipates from the extruded foam early. This poses a risk of causing a decrease in the heat insulating property.

The extruded styrenic resin foam in accordance with one or more embodiments of the present invention may have an average cell diameter of preferably 0.05 mm to 0.5 mm, more preferably 0.05 mm to 0.4 mm, and particularly preferably 0.05 mm to 0.3 mm, in a thickness direction of the extruded styrenic resin foam. In general, as the average cell diameter becomes smaller, a distance between cell walls in the foam becomes shorter. Accordingly, since a range of movement of the cells in the extruded foam is narrow while the shape is being imparted to the extruded foam in the extrusion foaming, it is difficult to deform the cells. This tends to make it difficult to (i) impart a beautiful surface to the extruded foam and (ii) increase the thickness of the extruded foam. In particular, in a case where the average cell diameter of the extruded styrenic resin foam is less than 0.05 mm in the thickness direction of the extruded styrenic resin foam, it tends to be considerably difficult to (i) impart a beautiful surface to the extruded foam and (ii) increase the thickness of the extruded foam. In a case where the average cell diameter of the extruded styrenic resin foam is more than 0.5 mm in the thickness direction of the extruded styrenic resin foam, the extruded styrenic resin foam may not achieve a sufficient heat insulating property.

Note that the average cell diameter of the extruded styrenic resin foam in accordance with one or more embodiments of the present invention is measured as follows with use of a microscope [manufactured by KEYENCE, DIGITAL MICROSCOPE VHX-900].

Three portions of an obtained extruded styrenic resin foam are observed under the microscope. Note that the three portions include (i) a portion in the middle of the extruded styrenic resin foam in a width direction of the extruded styrenic resin foam, (ii) a portion which is located 150 mm apart from one edge of the extruded styrenic resin foam toward the other edge of the extruded styrenic resin foam in the width direction, and (iii) a portion which is located 150 mm apart from the other edge of the extruded styrenic resin foam toward the one edge of the extruded styrenic resin foam in the width direction. Specifically, a first cross section of a middle portion, in the thickness direction, of each of the three portions is observed and a photograph of the first cross section is taken in a direction in which the extruded styrenic resin foam is extruded (hereinafter, referred to as an extrusion direction), and a second cross section of the middle portion, in the thickness direction, of each of the three portions is observed and a photograph of the second cross section is taken in the width direction. Note that the first cross section is a cross section in parallel to the width direction and the second cross section is a cross section perpendicular to the width direction. The observation was made with use of the microscope at a magnification of 100 times, and photographs of enlarged images of the three portions are taken with use of the microscope. Then, three 2-milimeter straight lines are arbitrarily drawn in the thickness direction in each of such magnified photographs (three straight lines for each observed direction at each observed portion), and the number “a” of cells in contact with the three straight lines is counted. From the number “a” thus counted, an average cell diameter A in the thickness direction is calculated for each observed direction at each observed portion by the following Expression (3). An average of average cell diameters thus calculated for the three portions (two directions at each portion) is regarded as an average cell diameter A (average) in the thickness direction of the extruded styrenic resin foam.

Average cell diameter A (mm) in a thickness direction at each observed portion=2×3/the number “a” of cells (3)

The three portions of the obtained extruded styrenic resin foam are observed under the microscope. Note that the three portions include (i) the portion in the middle of the extruded styrenic resin foam in the width direction of the extruded styrenic resin foam, (ii) the portion which is located 150 mm apart from the one edge of the extruded styrenic resin foam toward the other edge of the extruded styrenic resin foam in the width direction, and (iii) the portion which is located 150 mm apart from the other edge of the extruded styrenic resin foam toward the one edge of the extruded styrenic resin foam in the width direction. Specifically, a third cross section of the middle portion, in the thickness direction, of each of the three portions is observed and a photograph of the third cross section is taken in the width direction. Note that the third cross section is a cross section which is in parallel to the extrusion direction and which is perpendicular to the width direction. The observation was made with use of the microscope at a magnification of 100 times, and photographs of enlarged images of the three portions are taken with use of the microscope. Then, three 2-milimeter straight lines are arbitrarily drawn in the extrusion direction in such a magnified photograph (three straight lines for each observed portion), and the number “b” of cells in contact with the three straight lines is counted. From the number “b” thus counted, an average cell diameter B in the extrusion direction is calculated for each observed portion by the following Expression (4). An average of average cell diameters thus calculated for the three portions is regarded as an average cell diameter B (average) in the extrusion direction of the extruded styrenic resin foam.

Average cell diameter B (mm) in an extrusion direction at each observed portion=2×3/the number “b” of cells (4)

The three portions of the obtained extruded styrenic resin foam are observed under the microscope. Note that the three portions include (i) the portion in the middle of the extruded styrenic resin foam in the width direction of the extruded styrenic resin foam, (ii) the portion which is located 150 mm apart from the one edge of the extruded styrenic resin foam toward the other edge of the extruded styrenic resin foam in the width direction, and (iii) the portion which is located 150 mm apart from the other edge of the extruded styrenic resin foam toward the one edge of the extruded styrenic resin foam in the width direction. Specifically, a fourth cross section of the middle portion, in the thickness direction, of each of the three portions is observed and a photograph of the fourth cross section is taken in the extrusion direction. Note that the fourth cross section is a cross section which is in parallel to the width direction and which is perpendicular to the extrusion direction. The observation was made with use of the microscope at a magnification of 100 times, and photographs of enlarged images of the three portions are taken with use of the microscope. Then, three 2-milimeter straight lines are arbitrarily drawn in the width direction in such a magnified photograph (three straight lines for each observed portion), and the number “c” of cells in contact with the three straight lines is counted. From the number “c” thus counted, an average cell diameter C in the width direction is calculated for each observed portion by the following Expression (5). An average of average cell diameters thus calculated for the three portions is regarded as an average cell diameter C (average) in the width direction of the extruded styrenic resin foam.

Average cell diameter C (mm) in a width direction at each observed portion=2×3/the number “c” of cells (5)

The extruded styrenic resin foam in accordance with one or more embodiments of the present invention may have a cell deformation ratio of preferably not less than 0.7 and not more than 2.0, more preferably not less than 0.8 and not more than 1.5, still more preferably not less than 0.8 and not more than 1.2. In a case where the cell deformation ratio is less than 0.7, the extruded styrenic resin foam has low compressive strength. Accordingly, it may not be possible for the extruded foam to secure suitable strength. Furthermore, since the cells each attempt to return to a spherical shape, the extruded foam tends to be poor in maintaining dimensions (shape). In a case where the cell deformation ratio is more than 2.0, the number of cells in the thickness direction of the extruded foam is decreased. This reduces the heat insulating property enhancing effect which is brought about by a shape of each of the cells.

Note that the cell deformation ratio of the extruded styrenic resin foam in accordance with one or more embodiments of the present invention can be calculated from the following Expression (6) with use of the foregoing average cell diameters.

Cell deformation ratio (no unit)=A (average)/{[B (average)+C (average)]/2} (6)

The extruded styrenic resin foam in accordance with one or more embodiments of the present invention may have a thickness of preferably 10 mm to 150 mm, more preferably 20 mm to 130 mm, and particularly preferably 30 mm to 120 mm. The thickness falling within the above ranges brings about such an advantage that in a case where the extruded styrenic resin foam serves, for example, as a heat insulating material for a building or as a heat insulating material for a cool box or a refrigerator car, the extruded styrenic resin foam exhibits (i) an excellent heat insulating property, (ii) an excellent bending strength, and (iii) an excellent compressive strength.

Note that, as described in Examples and Comparative Examples of one or more embodiments of the present invention, after impartation of the shape by the extrusion foaming molding, both surfaces of the extruded styrenic resin foam, which both surfaces are plane surfaces each perpendicular to the thickness direction, may be each cut off at a depth of approximately 5 mm in the thickness direction so that the extruded styrenic resin foam has a product thickness. However, the thickness of the extruded styrenic resin foam in accordance with one or more embodiments of the present invention indicates a thickness of the extruded styrenic resin foam whose both surfaces are not cut off after the impartation of the shape by the extrusion foaming molding, unless otherwise specified.

The extruded styrenic resin foam in accordance with one or more embodiments of the present invention needs to have a plate shape without undulating in any of the extrusion direction, the width direction, and the thickness direction, so as to be suitably used as a heat insulating material, for example, (i) a heat insulating material for a building or (ii) a heat insulating material for a cool box or a refrigerator car. As has been described, in any of the following cases (1) through (3), for example, the resin itself becomes poor in stretch or it becomes difficult to deform the cells because the range of the movement of the cells in the extruded foam is narrow during the impartation of the shape by the extrusion foaming: (1) a case where the hydrofluoroolefin is used, (2) a case where the heat ray radiation inhibitor is used, and (3) a case where the average cell diameter of the styrene extruded foam is made fine. Therefore, in a case where, for example, any of the cases (1) through (3) above applies and where it is intended that the thickness of the extruded styrenic resin foam is adjusted by the extrusion foaming molding, it is not possible to impart the shape to the extruded styrenic resin foam, so that the extruded foam may undulate in at least one of the extrusion direction, the width direction, and the thickness direction of the extruded foam and may consequently not have a plate shape.

The surface property of the extruded styrenic resin foam in accordance with one or more embodiments of the present invention is particularly important in order that the stability is secured during the production. Furthermore, the surface property of the extruded styrenic resin foam in accordance with one or more embodiments of the present invention is particularly important, in a case where the extruded styrenic resin foam is used, as it is, as a product without cutting of the both surfaces of the extruded styrenic resin foam, which both surfaces are plane surfaces each perpendicular to the thickness direction. Therefore, the extruded styrenic resin foam in accordance with one or more embodiments of the present invention may need to have a beautiful surface property without having a flow mark, a crack, a partial peeling, or the like. As has been described, in any of the following cases (1) through (3), for example, the resin itself becomes poor in stretch or it becomes difficult to deform the cells because the range of the movement of the cells in the extruded foam is narrow during the impartation of the shape by the extrusion foaming: (1) a case where the hydrofluoroolefin is used, (2) a case where the heat ray radiation inhibitor is used, and (3) a case where the average cell diameter of the styrene extruded foam is made fine. Therefore, in any of the cases (1) through (3), there is a possibility that a flow mark, a crack, a partial peeling, or the like occurs on the surface of the extruded foam, so that the surface property is impaired. A flow mark indicates a trace of a flow of the molten resin and occurs on the both surfaces of the extruded foam, which both surfaces are plane surfaces each perpendicular to the thickness direction, in a case where, for example, the resin itself is rigid and poor in stretch. A crack occurs in a case where, for example, an excessive force is applied to the extruded foam, and is particularly likely to occur in a case where, for example, it is intended that the extruded foam is forcedly molded and the thickness of the extruded foam is increased in a state where the thickness of the extruded foam is not easily increased. A crack may occur on the both surfaces of the extruded foam, which both surfaces are plane surfaces each perpendicular to the thickness direction or may occur on an edge (side portion), in the width direction, of the extruded foam. In a worst-case scenario, the extruded foam being continuously produced may be torn off from a crack. A partial peeling may occur, in part or in whole, on the both surfaces of the extruded foam, which both surfaces are plane surfaces each perpendicular to the thickness direction, and/or the edge (side portion), in the width direction, of the extruded foam, in a case where, for example, a portion of the molten resin having been foamed is excessively solidified and, consequently, such a portion is stuck in a mold and turned up.

According to one or more embodiments of the present invention, it is possible to easily obtain an extruded styrenic resin foam which has an excellent heat insulating property and flame retardancy, a beautiful appearance, and a sufficient thickness suitable for use.

[2. Method for Producing Extruded Styrenic Resin Foam]

A method for producing an extruded styrenic resin foam in accordance with one or more embodiments of the present invention may be a production method used to produce an extruded styrenic resin foam described in the above [1. Extruded styrenic resin foam]. Out of arrangements used in the method for producing an extruded styrenic resin foam in accordance with one or more embodiments of the present invention, arrangements which have been already described in the above [1. Extruded styrenic resin foam] will not be described here.

Examples of the method for producing the extruded styrenic resin foam in accordance with one or more embodiments of the present invention encompass a method including the following steps (1) through (4) to be carried out in this order. (1) A styrenic resin, a flame retardant, and graphite and, as necessary, a stabilizer, a heat ray radiation inhibitor other than graphite, any other additive, or the like are supplied to a heat-melting section such as an extruder. In so doing, it is possible to add a saturated hydrocarbon having 3 to 5 carbon atoms and a hydrofluoroolefin and, as necessary, any other foaming agent to the styrenic resin under a high pressure condition at any stage. (2) A mixture of the styrenic resin, the flame retardant, the graphite, the saturated hydrocarbon having 3 to 5 carbon atoms, the hydrofluoroolefin, and the any other additive and/or the any other foaming agent, is regarded as a fluid gel (in other words, a molten resin). (3) The fluid gel is cooled to a temperature suitable for extrusion foaming. (4) The fluid gel is then extruded to a low pressure region through a die so that the fluid gel is foamed.

A heating temperature, at which the mixture is heated in the heat-melting section so that the mixture is melted, only needs to be equal to or higher than a temperature at which the styrenic resin melts. However, in one or more embodiments, the heating temperature is preferably a temperature at which degradation of molecules of the resin, which degradation is caused by an effect of an additive or the like, is prevented as much as possible, and is preferably, for example, 150° C. to 260° C. A time period, during which the mixture is melted and kneaded in the heat-melting section, varies depending on an amount of the styrenic resin extruded per unit time and/or a type of the extruder used as the heat-melting section and as a melting and kneading section. Therefore, the time period cannot be uniquely specified, and may be set as appropriate to a time period necessary for the styrenic resin, the foaming agent, and the additive to be uniformly dispersed and mixed together.

Examples of the melting and kneading section include a screw extruder. However, the melting and kneading section is not limited in particular, provided that the melting and kneading section is one that is used for usual extrusion foaming.

Examples of a foaming molding method in accordance with one or more embodiments of the present invention may include a foaming molding method in which the following steps (1) and (2), for example, are carried out in this order: (1) an extruded foam is obtained by releasing the fluid gel from a high pressure region to the low pressure region through a slit die whose opening, which is used for extrusion molding, has a linear slit shape; and then (2) the extruded foam is molded into a plate-shaped foam, having a large cross-sectional area, with use of, for example, (i) a mold attached to or provided so as to be in contact with the slit die and (ii) a forming roll provided on a downstream side of the mold so as to be adjacent to the mold. By (i) adjusting a shape of a surface of the mold on which surface the extruded foam flows and (ii) adjusting a temperature of the mold, the foam is caused to achieve a desired cross-sectional shape, a desired surface property, and a desired quality.

The method for producing an extruded styrenic resin foam in accordance with one or more embodiments of the present invention can be arranged as follows.

[1] A method for producing an extruded styrenic resin foam, including the step of foaming a styrenic resin composition containing: a styrenic resin; a flame retardant contained in an amount of 0.5 parts by weight to 8.0 parts by weight relative to 100 parts by weight of the styrenic resin; graphite contained in an amount of 1.0 parts by weight to 5.0 parts by weight relative to 100 parts by weight of the styrenic resin; a saturated hydrocarbon having 3 to 5 carbon atoms and serving as a foaming agent; and a hydrofluoroolefin serving as a foaming agent, (I) the hydrofluoroolefin in the extruded styrenic resin foam being contained in an amount of 0.05 mol to 0.40 mol relative to 1 kg of the extruded styrenic resin foam, (II) the saturated hydrocarbon having 3 to 5 carbon atoms in the extruded styrenic resin foam being contained in an amount of 0.10 mol to 0.40 mol relative to 1 kg of the extruded styrenic resin foam, and (III) a total amount of the amount of the saturated hydrocarbon having 3 to 5 carbon atoms and the amount of the hydrofluoroolefin, which are contained in the extruded styrenic resin foam, being 0.30 mol to 0.50 mol relative to 1 kg of the extruded styrenic resin foam.

[2] The method described in [1], in which: the extruded styrenic resin foam has passed the measurement method A specified in JIS A9521 for a flammability; and the extruded styrenic resin foam has a combustion spreading length of not more than 10 mm.

[3] The method described in [1] or [2], in which the extruded styrenic resin foam has (i) an apparent density of 20 kg/m³ to 45 kg/m³ and (ii) a closed cell ratio of not less than 90%.

[4] The method described in any one of [1] through [3], in which the styrenic resin composition further contains, as a foaming agent, at least one selected from the group consisting of dimethyl ether, ethyl chloride, and methyl chloride, the at least one selected from the group consisting of the dimethyl ether, the ethyl chloride, and the methyl chloride being added in an amount of 0.5 parts by weight to 15 parts by weight relative to 100 parts by weight of the styrenic resin.

[5] The method described in any one of [11] through [4], in which the saturated hydrocarbon having 3 to 5 carbon atoms is isobutane.

[6] The method described in any one of [11] through [5], in which the hydrofluoroolefin is a tetrafluoropropene.

[7] The method described in any one of [11] through [6], in which the extruded styrenic resin foam has a thickness of 10 mm to 150 mm.

[8] The method described in any one of [11] through [7], in which: the flame retardant is a bromine flame retardant; and the styrenic resin composition contains the bromine flame retardant in an amount of 0.5 parts by weight to 5.0 parts by weight relative to 100 parts by weight of the styrenic resin.

One or more embodiments of the present invention can be arranged as follows.

[1] An extruded styrenic resin foam containing: a styrenic resin; a flame retardant contained in an amount of 0.5 parts by weight to 8.0 parts by weight relative to 100 parts by weight of the styrenic resin; graphite contained in an amount of 1.0 parts by weight to 5.0 parts by weight relative to 100 parts by weight of the styrenic resin; a saturated hydrocarbon having 3 to 5 carbon atoms and serving as a foaming agent; and a hydrofluoroolefin serving as a foaming agent, (I) the hydrofluoroolefin in the extruded styrenic resin foam being contained in an amount of 0.05 mol to 0.40 mol relative to 1 kg of the extruded styrenic resin foam, (II) the saturated hydrocarbon having 3 to 5 carbon atoms in the extruded styrenic resin foam being contained in an amount of 0.10 mol to 0.40 mol relative to 1 kg of the extruded styrenic resin foam, and (III) a total amount of the amount of the saturated hydrocarbon having 3 to 5 carbon atoms and the amount of the hydrofluoroolefin, which are contained in the extruded styrenic resin foam, being 0.30 mol to 0.50 mol relative to 1 kg of the extruded styrenic resin foam.

[2] The extruded styrenic resin foam described in [1], in which: the extruded styrenic resin foam has passed the measurement method A specified in JIS A9521 for a flammability; and the extruded styrenic resin foam has a combustion spreading length of not more than 10 mm.

[3] The extruded styrenic resin foam described in [1] or [2], in which the extruded styrenic resin foam has (i) an apparent density of 20 kg/m³ to 45 kg/m³ and (ii) a closed cell ratio of not less than 90%.

[4] The extruded styrenic resin foam described in any one of [1] through [3], further containing, as a foaming agent, at least one selected from the group consisting of dimethyl ether, ethyl chloride, and methyl chloride, the at least one selected from the group consisting of the dimethyl ether, the ethyl chloride, and the methyl chloride being added in an amount of 0.5 parts by weight to 15 parts by weight relative to 100 parts by weight of the styrenic resin.

[5] The extruded styrenic resin foam described in any one of [1] through [4], in which the saturated hydrocarbon having 3 to 5 carbon atoms is isobutane.

[6] The extruded styrenic resin foam described in any one of [1] through [5], in which the hydrofluoroolefin is a tetrafluoropropene.

[7] The extruded styrenic resin foam described in any one of [1] through [6], in which the extruded styrenic resin foam has a thickness of 10 mm to 150 mm.

[8] The extruded styrenic resin foam described in any one of [1] through [7], in which: the flame retardant is a bromine flame retardant; and the bromine flame retardant is contained in an amount of 0.5 parts by weight to 5.0 parts by weight relative to 100 parts by weight of the styrenic resin.

[9] A method for producing an extruded styrenic resin foam described in any one of [1] through [8].

### EXAMPLES

The following description will discuss Examples of one or more embodiments of the present invention. Note that the present invention is obviously not limited to Examples below.

Raw materials used in Examples and Comparative Examples are as follows.

Base Resin

Styrenic resin A [produced by PS Japan Corporation, G9401; MFR 2.2 g/10 minutes] ⋅ Styrenic resin B [produced by PS Japan Corporation, 680; MFR 7.0 g/10 minutes]

Heat Ray Radiation Inhibitor

Graphite [produced by MARUTOYO Co., Ltd., M-885; flake (scale-like) graphite, primary particle diameter 5.5 μm, fixed carbon content 89/n %]

Titanium oxide [produced by Sakai Chemical Industry Co., Ltd., R-7E; primary particle diameter 0.23 μm]

Flame Retardant

Mixed bromine flame retardant [produced by Dai-ichi Kogyo Seiyaku Co., Ltd., GR-125P] made up of tetrabromobisphenol A-bis(2,3-dibromo-2-methylpropyl)ether and tetrabromobisphenol A-bis(2,3-dibromopropyl)ether

Brominated styrene-butadiene block polymer [produced by Chemtula, EMERALD INNOVATION #3000]

Auxiliary Flame Retardant

Triphenylphosphine oxide [SUMITOMO SHOJI CHEMICALS CO., LTD.]

Radical Generating Agent

Poly-1,4-diisopropylbenzene [produced by UNITED INITIATORS, CCPIB]

Stabilizer

Bisphenol-A-glycidyl ether [produced by ADEKA Corporation, EP-13]

Cresol novolac type epoxy resin [produced by HUNTSMAN Japan, ECN-1280]

Dipentaerythritol-adipic acid reaction mixture [produced by Ajinomoto Fine-Techno Co., Inc., PLENLIZER ST210]

Pentaerythritol tetrakis[3-(3′,5′-di-tert-butyl-4′-hydroxyphenyl)propionate][produced by Chemtula, ANOX20]

3,9-bis(2,4-di-tert-butylphenoxy)-2,4,8,10-tetraoxa-3,9-dip hospha-spiro [5.5] undecane [produced by Chemtula, Ultranox626]

Triethylene glycol-bis-3-(3-tert-butyl-4-hydroxy-5-methylphenyl)propionate [produced by Songwon Japan K.K., SONGNOX 2450FF]

Other Additives

Talc [produced by Hayashi-Kasei Co., Ltd., Talcan Powder PK-Z]

Calcium stearate [produced by Sakai Chemical Industry Co., Ltd., SC-P]

Bentonite [produced by HOJUN Co., Ltd., BEN-GEL BLITE K11]

Silica [produced by Evonik Degussa Japan Co., Ltd., Carplex BS-304F]

Amide ethylene-bis-stearate [produced by Nichiyu Corporation, ALFLOW H-50S]

Foaming Agent

HFO-1234ze [produced by Honeywell Japan]

Dimethyl ether [produced by Iwatani Corporation]

Isobutane [produced by Mitsui Chemicals, Inc.]

Ethyl chloride [produced by Nihon Tokushu Kagaku Kogyo K.K.]

Water [tap water in Settsu City, Osaka]

In each of Examples and Comparative Examples, an extruded styrenic resin foam was evaluated in terms of a thickness (before cutting), a HFO-1234ze content and an isobutane content in 1 kg of the foam, an apparent density, a closed cell ratio, an average cell diameter, a cell deformation ratio, a thermal conductivity, a JIS flammability, a combustion spreading length, and an appearance, in accordance with the following methods.

(1) Thickness of Extruded Styrenic Resin Foam

Thicknesses of three portions of the extruded styrenic resin foam were measured with use of a caliper [manufactured by Mitutoyo Corporation, M-type standard caliper N30]. The three portions included (i) a portion in the middle of the extruded styrenic resin foam in a width direction of the extruded styrenic resin foam, (ii) a portion which was located 150 mm apart from one edge of the extruded styrenic resin foam toward the other edge of the extruded styrenic resin foam in the width direction, and (iii) a portion which was located 150 mm apart from the other edge of the extruded styrenic resin foam toward the one edge of the extruded styrenic resin foam in the width direction. An average of the thicknesses of the three portions was regarded as a thickness of the extruded styrenic resin foam.

(2) HFO-1234Ze Content and Isobutane Content in 1 kg of Foam

The obtained extruded styrenic resin foam was left to stand still under the third-grade standard temperature condition (23° C.±+5° C.) and the third-grade standard humidity condition (50+20, −10% R.H.) each specified in JIS K 7100. Then, a HFO-1234ze content and an isobutane content 7 days after the production were evaluated by the following method with use of the following apparatuses.

a) Apparatus; gas chromatograph GC-2014 [manufactured by Shimadzu Corporation]
b) Column; G-Column G-950 25UM [manufactured by Chemicals Evaluation and Research Institute, Japan]
c) Measurement conditions;

Injection port temperature: 65° C.

Column temperature: 80° C.

Detector temperature: 100° C.

Carrier gas: high-purity helium

Carrier gas flow rate: 30 mL/minute

Detector: TCD

Electric current: 120 mA

A test piece having a weight of approximately 1.2 g was cut off from the foam. Note that the weight varies depending on an apparent density of the test piece. The test piece was put in a closable glass vessel (hereinafter, referred to as a “closed vessel”) having a capacity of approximately 130 cc. Air in the closed vessel was removed with use of a vacuum pump. Subsequently, the closed vessel was heated at 170° C. for 10 minutes so that a foaming agent in the foam was taken out into the closed vessel. After a temperature of the closed vessel returned to an ordinary temperature, helium was introduced into the closed vessel so that a pressure inside the closed vessel returned to an atmospheric pressure. Thereafter, 40 μL of a mixed gas containing the HFO-1234ze and isobutane was taken out with use of a microsyringe, and was evaluated with use of the above apparatuses a) and b) under the above conditions c).

(3) Apparent Density (Kg/m³)

A weight, a length, a width, and the thickness of an obtained extruded styrenic resin foam were measured.

From the weight, the length, the width, and the thickness thus measured, a density of the foam was calculated based on the following Expression (7). A unit was converted into kg/m³.

Apparent density (g/cm³)=a weight (g) of a foam/a volume (cm³) of the foam (7)

(4) Closed Cell Ratio

Test pieces each having a thickness of 40 mm, a length (extrusion direction) of 25 mm, and a width of 25 mm were cut off from three portions of the obtained extruded styrenic resin foam. The three portions included (i) a portion in the middle of the extruded styrenic resin foam in the width direction, (ii) a portion which was located 150 mm apart from the one edge of the extruded styrenic resin foam toward the other edge of the extruded styrenic resin foam in the width direction, and (iii) a portion which was located 150 mm apart from the other edge of the extruded styrenic resin foam toward the one edge of the extruded styrenic resin foam in the width direction. Subsequently, closed cell ratios of the test pieces were each measured in accordance with Procedure C of ASTM-D2856-70, and each calculated based on the following Expression (8). An average of the closed cell ratios of the test pieces (that is, the three portions) was regarded as a closed cell ratio of the extruded styrenic resin foam.

Closed cell ratio (%)=(V1−W/ρ)×100/(V2−W/ρ) (8)

wherein: V1 (cm³) represents a true volume (excluding a volume of cells other than closed cells) of a test piece which true volume is measured with use of an air comparison pycnometer [manufactured by TOKYO SCIENCE., model 1000]; V2 (cm³) represents an apparent volume of the test piece which apparent volume is calculated from external dimensions of the test piece that are measured with use of a caliper [manufactured by Mitutoyo Corporation, M-type standard caliper N30]; W (g) represents a total weight of the test piece; and p (g/cm³) represents a density of a styrenic resin constituting an extruded foam and is set to 1.05 (g/cm³).

(5) Average Cell Diameter and Cell Deformation Ratio in Thickness Direction

An average cell diameter and a cell deformation ratio of the obtained extruded styrenic resin foam were evaluated as described above.

(6) Thermal Conductivity

A test piece having a thickness (product thickness), a length (extrusion direction) of 300 mm, and a width of 300 mm was cut off from the extruded styrenic resin foam. A thermal conductivity of the test piece was measured with use of a thermal conductivity measuring device [manufactured by EKO Instrument, HC-074] at an average temperature of 23° C. in accordance with JIS A 9521. Note that, after the extruded styrenic resin foam was produced, (i) the test piece having the above dimensions was cut off from the extruded styrenic resin foam, (ii) the test piece was left to stand still under the third-grade standard temperature condition (23° C.±5° C.) and the third-grade standard humidity condition (50^{+20, -10}% R.H.) each specified in JIS K 7100, and then (iii) the above measurement was carried out 7 days after the production. The value of the thermal conductivity obtained by the measurement was determined by the following criteria.

Good (Accepted): the thermal conductivity was not more than 0.0245 W/mK.
Poor (Rejected): the thermal conductivity was more than 0.0245 W/mK.

(7) JIS Flammability and Combustion Spreading Length

A test piece having a thickness of 10 mm, a length of 200 mm, and a width of 25 mm was cut off from the extruded styrenic resin foam. A JIS flammability of the test piece was evaluated by the following criteria in accordance with JIS A 9521. Note that, after the extruded styrenic resin foam was produced, (i) the test piece having the above dimensions was cut off from the extruded styrenic resin foam, (ii) the test piece was left to stand still under the third-grade standard temperature condition (23° C.±5° C.) and the third-grade standard humidity condition (50^{+20, -10}% R.H.) each specified in JIS K 7100, and then (iii) the above measurement was carried out 7 days after the production.

Good: the test piece satisfied the following criterion: flame went out within three seconds, there was no afterglow, and the test piece did not burn beyond a burning limit indication line.
Poor: the test piece did not satisfy the above criterion.

In addition, in regard to gas surface combustion which is a phenomenon in which combustion spreads only on a surface of a foam due to a flammable gas contained in the foam (in cells), a length (mm) of the spread of combustion beyond a burning limit indication line was measured as “combustion spreading length”. This “combustion spreading length” was also measured by obtaining an average of values of 5 test pieces as in the case of the JIS flammability. In a case where the flame disappeared without spreading beyond the burning limit indication line (i.e., without reaching the burning limit indication line), a remaining distance to the burning limit indication line was regarded as a negative value. In general, such a negative value is regarded as zero. However, for making the effect of one or more embodiments of the present invention evident, the negative values were accurately indicated.

(8) Appearance of Foam

An appearance of the foam was determined by the following criteria on the basis of results of evaluating a shape and a surface property of the foam as in (8)-1 and (8)-2.

Accepted: both of the shape and the surface property were evaluated as “Good.”
Rejected: at least one of the shape and the surface property was evaluated as “Unsatisfactory” or “Poor.”

(8)-1. Shape

The extruded foam which had been subjected to a forming roll but had not been cut was visually observed and evaluated by the following criteria. Good: the extruded foam had a plate shape without undulating in any of the extrusion direction, the width direction, and the thickness direction of the extruded foam.

Poor: the extruded foam did not have a plate shape, and undulated in at least one of the extrusion direction, the width direction, and the thickness direction of the extruded foam.

(8)-2. Surface Property

Before and after being cut, the extruded foam was visually observed and evaluated by the following criteria. Note that a surface indicates a surface perpendicular to the thickness direction. Note also that “after being cut” indicates a state where both surfaces of the extruded styrenic resin foam were each cut off at a depth of 5 mm in the thickness direction on the basis of the thickness (average of the thicknesses of the three portions) of the extruded styrenic resin foam.

Good: the extruded styrenic resin foam had beautiful surfaces without having a defect such as a flow mark, a crack, or a partial peeling.
Unsatisfactory: the extruded styrenic resin foam had a defect, such as a flow mark, a crack, or a partial peeling, on its surface(s), but had no trace of such a defect on its surface(s) after being cut.
Poor: the extruded styrenic resin foam had a defect, such as a flow mark, a crack, or a partial peeling, on its surface(s), and even had a trace of such a defect on its surface(s) after being cut.

In Examples and Comparative Examples, graphite and titanium oxide were each added in a form of a masterbatch prepared by the following method.

[Preparation of Graphite Masterbatch A]

Into a Banbury mixer, 100 parts by weight of a styrenic resin A [produced by PS Japan Corporation, G9401], serving as a base resin, was introduced. Furthermore, 102 parts by weight of graphite [produced by MARUTOYO Co., Ltd., M-885] and 2.0 parts by weight of amide ethylene-bis-stearate [produced by Nichiyu Corporation, ALFLOW H-50S], relative to 100 parts by weight of the styrenic resin A, were introduced into the Banbury mixer. Then, those materials were melted and kneaded for 20 minutes under a load of 5 kgf/cm² without being heated and cooled. At that time, a temperature of the resin was 190° C. The resin thus obtained was supplied to an extruder and was extruded at a discharge quantity of 250 kg/hr through a die, which was attached to an end of the extruder and had a small hole, to obtain a strand-shaped resin. The strand-shaped resin was cooled and solidified in a water tank at 30° C. The strand-shaped resin was then cut to obtain a masterbatch.

[Preparation of Graphite Masterbatch B]

Into a Banbury mixer, 100 parts by weight of a styrenic resin B [produced by PS Japan Corporation, 680], serving as a base resin, was introduced. Furthermore, 102 parts by weight of graphite [produced by MARUTOYO Co., Ltd., M-885] and 2.0 parts by weight of amide ethylene-bis-stearate [produced by Nichiyu Corporation, ALFLOW H-50S], relative to 100 parts by weight of the styrenic resin B, were introduced into the Banbury mixer. Then, those materials were melted and kneaded for 20 minutes under a load of 5 kgf/cm² without being heated and cooled. At that time, a temperature of the resin was 180° C. The resin thus obtained was supplied to an extruder and was extruded at a discharge quantity of 250 kg/hr through a die, which was attached to an end of the extruder and had a small hole, to obtain a strand-shaped resin. The strand-shaped resin was cooled and solidified in a water tank at 30° C. The strand-shaped resin was then cut to obtain a masterbatch.

[Preparation of Titanium Oxide Masterbatch A]

Into a Banbury mixer, 100 parts by weight of a styrenic resin A [produced by PS Japan Corporation, G9401], serving as a base resin, was introduced. Furthermore, 154 parts by weight of titanium oxide [produced by Sakai Chemical Industry Co., Ltd., R-7E] and 2.6 parts by weight of amide ethylene-bis-stearate [produced by Nichiyu Corporation, ALFLOW H-50S], relative to 100 parts by weight of the styrenic resin A, were introduced into the Banbury mixer. Then, those materials were melted and kneaded for 20 minutes under a load of 5 kgf/cm² without being heated and cooled. At that time, a temperature of the resin was 190° C. The resin thus obtained was supplied to an extruder and was extruded at a discharge quantity of 250 kg/hr through a die, which was attached to an end of the extruder and had a small hole, to obtain a strand-shaped resin. The strand-shaped resin was cooled and solidified in a water tank at 30° C. The strand-shaped resin was then cut to obtain a masterbatch.

[Preparation of Titanium Oxide Masterbatch B]

Into a Banbury mixer, 100 parts by weight of a styrenic resin B [produced by PS Japan Corporation, 680], serving as a base resin, was introduced. Furthermore, 154 parts by weight of titanium oxide [produced by Sakai Chemical Industry Co., Ltd., R-7E] and 2.6 parts by weight of amide ethylene-bis-stearate [produced by Nichiyu Corporation, ALFLOW H-50S], relative to 100 parts by weight of the styrenic resin B, were introduced into the Banbury mixer. Then, those materials were melted and kneaded for 20 minutes under a load of 5 kgf/cm² without being heated and cooled. At that time, a temperature of the resin was 180° C. The resin thus obtained was supplied to an extruder and was extruded at a discharge quantity of 250 kg/hr through a die, which was attached to an end of the extruder and had a small hole, to obtain a strand-shaped resin. The strand-shaped resin was cooled and solidified in a water tank at 30° C. The strand-shaped resin was then cut to obtain a masterbatch.

### Example 1

[Preparation of Resin Mixture]

Prepared were 96.6 parts by weight of the styrenic resin A [produced by PS Japan Corporation, G9401] serving as a base resin, 5.0 parts by weight of the graphite masterbatch A serving as a heat ray radiation inhibitor, and 2.5 parts by weight of the titanium oxide masterbatch A serving as a heat ray radiation inhibitor. Specifically, relative to 100 parts by weight of the styrenic resin A (including styrenic resins A contained in the graphite masterbatch A and in the titanium oxide masterbatch A), 2.5 parts by weight of the graphite serving as a heat ray radiation inhibitor and 1.5 parts by weight of the titanium oxide serving as a heat ray radiation inhibitor were prepared. Further prepared were 3.0 parts by weight of the mixed bromine flame retardant [produced by Dai-ichi Kogyo Seiyaku Co., Ltd., GR-125P] made up of tetrabromobisphenol A-bis(2,3-dibromo-2-methylpropyl)ether and tetrabromobisphenol A-bis(2,3-dibromopropyl)ether and serving as a flame retardant, 1.0 part by weight of the triphenylphosphine oxide [SUMITOMO SHOJI CHEMICALS CO., LTD.] serving as an auxiliary flame retardant, 0.50 parts by weight of the talc [produced by Hayashi-Kasei Co., Ltd., Talcan Powder PK-Z] serving as a cell diameter adjusting agent, 0.20 parts by weight of the bisphenol-A-glycidyl ether [produced by ADEKA Corporation, EP-13] serving as a stabilizer, 0.20 parts by weight of the triethylene glycol-bis-3-(3-t-butyl-4-hydroxy-5-methylphenyl)propionate [produced by Songwon Japan K.K., SONGNOX 2450FF] serving as a stabilizer, 0.10 parts by weight of the dipentaerythritol-adipic acid reaction mixture [produced by Ajinomoto Fine-Techno Co., Inc., PLENLIZER ST210] serving as a stabilizer, 0.20 parts by weight of the calcium stearate [produced by Sakai Chemical Industry Co., Ltd., SC-P] serving as a lubricant, 0.40 parts by weight of the bentonite [produced by HOJUN Co., Ltd., BEN-GEL BLITE K11] serving as a water absorbing medium, and 0.40 parts by weight of the silica [produced by Evonik Degussa Japan Co., Ltd., Carplex BS-304F] serving as a water absorbing medium, relative to 100 parts by weight of the styrenic resin A. Then, these were dry-blended.

[Preparation of Extruded Foam]

A resin mixture thus obtained was supplied, at approximately 950 kg/hr, to an extruder which was made up of a single screw extruder (first extruder) having a screw diameter of 150 mm, a single screw extruder (second extruder) having a screw diameter of 200 mm, and a cooling device that were connected in series.

The resin mixture supplied to the first extruder was (i) heated to a resin temperature of 240° C. so that the resin mixture was melted or plasticized and (ii) kneaded. Subsequently, a foaming agent (1.5 parts by weight of the HFO-1234ze, 2.0 parts by weight of the isobutane, 2.8 parts by weight of the dimethyl ether, and 0.9 parts by weight of the water, relative to 100 parts by weight of the base resin) was injected into the resin mixture in a vicinity of an end of the first extruder. Thereafter, the resin mixture was cooled to a resin temperature of 121° C. in the second extruder, which was connected to the first extruder, and the cooling device. Then, the resin mixture was extruded to an atmosphere through a nozzle (slit die), which was provided to an end of the cooling device and which had a rectangular cross section having a thickness of 6 mm and a width of 400 mm, at a foaming pressure of 3.0 MPa so that the resin mixture was foamed. Then, with use of a mold attached to the nozzle and a forming roll provided on a downstream side of the mold, an extruded foam was obtained which had a cross section having a thickness of 60 mm and a width of 1000 mm. The extruded foam was then cut with use of a cutter so as to have a thickness of 50 mm, a width of 910 mm, and length of 1820 mm. Table 1 shows results of evaluating an obtained foam.

### Examples 2 Through 6

Extruded foams were obtained as in Example 1, except that a type(s) and an amount(s) of a material(s) blended, and/or a production condition(s) was/were changed as in Table 1. Table 1 shows the physical properties of obtained extruded foams. Note that each of the graphite and the titanium oxide was prepared as a form of a masterbatch of a styrenic resin in advance as described above and were introduced during production of a resin mixture. In a case where the masterbatch was used, 100.0 parts by weight of a base resin was defined as a total amount of the base resin including the base resin contained in the masterbatch.

### Comparative Examples 1 Through 6

Extruded foams were obtained as in Example 1, except that a type(s) and an amount(s) of a material(s) blended, and/or a production condition(s) was/were changed as in Table 2. Table 2 shows the physical properties of obtained extruded foams. Note that each of the graphite and the titanium oxide was prepared as a form of a masterbatch of a styrenic resin in advance as described above and was introduced during production of a resin mixture. In a case where the masterbatch was used, 100.0 parts by weight of a base resin was defined as a total amount of the base resin including the base resin contained in the masterbatch.

TABLE 1

| | | | | E1 | E2 | E3 | E4 | E5 | E6 |
|---|---|---|---|---|---|---|---|---|---|
| Blend | Base resin | Styrenic resin A G9401 | PBW | 96.6 | 96.6 | 96.6 | 96.6 | 0 | 96.6 |
| | *1 | | | (100.0) | (100.0) | (100.0) | (100.0) | | (100.0) |
| | | Styrenic resin B 680 | PBW | 0 | 0 | 0 | 0 | 96.6 | 0 |
| | | | | | | | | (100.0) | |
| | Heat ray | Graphite masterbatch A | PBW | 5.0 (2.5) | 5.0 (2.5) | 5.0 (2.5) | 5.0 (2.5) | 0 | 5.0 (2.5) |
| | radiation | Graphite masterbatch B | PBW | 0 | 0 | 0 | 0 | 5.0 (2.5) | 0 |
| | inhibitor | Titanium oxide masterbatch A | PBW | 2.5 (1.5) | 2.5 (1.5) | 2.5 (1.5) | 2.5 (1.5) | 0 | 2.5 (1,5) |
| | Masterbatch | Titanium oxide masterbatch B | PBW | 0 | 0 | 0 | 0 | 2.5 (1.5) | 0 |
| | *2 | | | | | | | | |
| | Flame retardant | GR-125P | PBW | 3.0 | 3.0 | 3.0 | 3.0 | 0 | 3.0 |
| | | EMERALD INNOVATION | PBW | 0 | 0 | 0 | 0 | 3.0 | 0 |
| | | #3000 | | | | | | | |
| | Auxiliary flame | Triphenylphosphine oxide | PBW | 1.0 | 1.0 | 1.0 | 1.0 | 0.50 | 1.0 |
| | retardant | | | | | | | | |
| | Radical | CCPIB | PBW | 0 | 0 | 0 | 0 | 0.10 | 0 |
| | generating | | | | | | | | |
| | agent | | | | | | | | |
| | Cell diameter | Talc | PBW | 0.50 | 0.50 | 0.50 | 0.50 | 0.20 | 0.50 |
| | adjusting agent | | | | | | | | |
| | Stabilizer | EP-13 | PBW | 0.20 | 0.20 | 0.20 | 0.20 | 0.15 | 0.20 |
| | | ECN-1280 | PBW | 0 | 0 | 0 | 0 | 0.15 | 0 |
| | | PLENLIZER ST210 | PBW | 0.10 | 0.10 | 0.10 | 0.10 | 0.20 | 0.10 |
| | | ANOX20 | PBW | 0 | 0 | 0 | 0 | 0.30 | 0 |
| | | Ultranox626 | PBW | 0 | 0 | 0 | 0 | 0.015 | 0 |
| | | SONGNOX 2450FF | PBW | 0.20 | 0.20 | 0.20 | 0.20 | 0 | 0.20 |
| | Lubricant | SC-P | PBW | 0.20 | 0.20 | 0.20 | 0.20 | 0.10 | 0.20 |
| | Water absorbing | BEN-GEL BLITE K11 | PBW | 0.40 | 0.40 | 0.40 | 0.40 | 0.40 | 0.40 |
| | medium | Carplex BS-304F | PBW | 0.40 | 0.40 | 0.40 | 0.40 | 0.40 | 0.40 |
| | Foaming agent | HFO-1234ze | PBW | 1.5 | 2.5 | 3.5 | 4.5 | 2.5 | 2.5 |
| | | Isobutane | PBW | 2.0 | 1.6 | 1.1 | 1.0 | 1.6 | 1.6 |
| | | Dimethyl ether | PBW | 2.8 | 2.8 | 2.8 | 2.6 | 2.8 | 0 |
| | | Ethyl chloride | PBW | 0 | 0 | 0 | 0 | 0 | 5.5 |
| | | Water | PBW | 0.9 | 0.9 | 0.9 | 0.9 | 0.9 | 0 |
| | Amount of | HFO-1234ze | mol | 0.11 | 0.19 | 0.26 | 0.33 | 0.19 | 0.18 |
| | foaming agent | Isobutane | mol | 0.29 | 0.23 | 0.16 | 0.14 | 0.23 | 0.23 |
| | added | Dimethyl ether | mol | 0.52 | 0.52 | 0.51 | 0.47 | 0.52 | 0 |
| | (Relative to 1 | Ethyl chloride | mol | 0 | 0 | 0 | 0 | 0 | 0.71 |
| | kg of foam) | Water | mol | 0.43 | 0.42 | 0.42 | 0.42 | 0.43 | 0 |
| | | Total of all foaming agents | mol | 1.35 | 1.36 | 1.36 | 1.37 | 1.37 | 1.13 |
| Production | Foaming temperature | | ° C. | 121 | 120 | 119 | 120 | 116 | 120 |
| condition | Thickness of slit die | | mm | 6 | 6 | 6 | 5 | 6 | 6 |
| | Foaming pressure | | MPa | 3.0 | 3.0 | 3.0 | 4.0 | 3.0 | 3.0 |
| Physical | Thickness of extruded styrenic resin foam | | mm | 60 | 60 | 60 | 60 | 60 | 60 |
| properties | (before cutting) | | | | | | | | |
| of | Foaming agent | HFO-1234ze | mol | 0.11 | 0.18 | 0.25 | 0.31 | 0.18 | 0.17 |
| extruded | content | Isobutane | mol | 0.28 | 0.22 | 0.15 | 0.14 | 0.22 | 0.22 |
| foam | (Relative to 1 | Total | mol | 0.39 | 0.40 | 0.40 | 0.45 | 0.40 | 0.39 |
| | kg of foam) | | | | | | | | |
| | Apparent density | | kg/m³ | 32 | 32 | 33 | 34 | 32 | 31 |
| | Closed cell ratio | | % | 95 | 95 | 96 | 95 | 95 | 95 |
| | Average cell diameter | | mm | 0.2 | 0.1 | 0.1 | 0.1 | 0,1 | 0.2 |
| | Cell deformation ratio | | — | 1.0 | 1.1 | 1.1 | 1.1 | 1.1 | 1.0 |
| | Thermal conductivity | | W/mK | 0.024 | 0.023 | 0.023 | 0.023 | 0.023 | 0.022 |
| | (after 7 days passed since production) | | | | | | | | |
| | Judgment on thermal conductivity | | — | Good | Good | Good | Good | Good | Good |
| | JIS flammability (after 7 days passed since | | — | Good | Good | Good | Good | Good | Good |
| | production) | | | | | | | | |
| | Combustion spreading length | | mm | −5 | −10 | −15 | −15 | −5 | −10 |
| | (after 7 days passed since production) | | | | | | | | |
| | Appearance | Shape | — | Good | Good | Good | Good | Good | Good |
| | | Surface property | — | Good | Good | Good | Good | Good | Good |
| | | Judgment | — | Accepted | Accepted | Accepted | Accepted | Accepted | Accepted |

Abbreviations:
* E1 through E6 stand for Examples 1 through 6, respectively.
* PBW stands for parts by weight.
Annotations:
*1: The numbers within the parentheses represent the total amounts (unit: parts by weight) including the styrenic resin A or the styrenic resin B contained in the heat ray radiation inhibitor masterbatch.
*2: The numbers within the parentheses represent addition amounts (unit: parts by weight), relative to 100 parts by weight of the styrenic resin, of graphite or titanium oxide which is contained in the heat ray radiation inhibitor masterbatch.

TABLE 2

| | | | | CW1 | CW2 | CW3 | CW4 | CW5 | CW6 |
|---|---|---|---|---|---|---|---|---|---|
| Blend | Base resin | Styrenic resin A G9401 | PBW | 96.6 | 96.6 | 96.6 | 96.6 | 96.6 | 96.6 |
| | *1 | | | (100.0) | (100.0) | (100.0) | (100.0) | (100.0) | (100.0) |
| | | Styrenic resin B 680 | PBW | 0 | 0 | 0 | 0 | 0 | 0 |
| | Heat ray | Graphite masterbatch A | PBW | 5.0 (2.5) | 5.0 (2.5) | 5.0 (2.5) | 5.0 (2.5) | 5.0 (2.5) | 5.0 (2.5) |
| | radiation | Graphite masterbatch B | PBW | 0 | 0 | 0 | 0 | 0 | 0 |
| | inhibitor | Titanium oxide | PBW | 2.5 (1.5) | 2.5 (1.5) | 2.5 (1.5) | 2.5 (1.5) | 2.5 (1.5) | 2.5 (1.5) |
| | Masterbatch | masterbatch A | | | | | | | |
| | *2 | Titanium oxide | PBW | 0 | 0 | 0 | 0 | 0 | 0 |
| | | masterbatch B | | | | | | | |
| | Flame retardant | GR-125P | PBW | 3.0 | 3.0 | 3.0 | 3.0 | 3.0 | 3.0 |
| | | EMERALD INNOVATION | PBW | 0 | 0 | 0 | 0 | 0 | 0 |
| | | #3000 | | | | | | | |
| | Auxiliary flame | Triohenylohosphine oxide | PBW | 1.0 | 1.0 | 1.0 | 1.0 | 1.0 | 1.0 |
| | retardant | | | | | | | | |
| | Radical | CCPIB | PBW | 0 | 0 | 0 | 0 | 0 | 0 |
| | generating | | | | | | | | |
| | agent | | | | | | | | |
| | Cell diameter | Talc | PBW | 0.50 | 0.50 | 0.50 | 0.50 | 0.50 | 0.50 |
| | adiusting agent | | | | | | | | |
| | Stabilizer | EP-13 | PBW | 0.20 | 0.20 | 0.20 | 0.20 | 0.20 | 0.20 |
| | | ECN-1280 | PBW | 0 | 0 | 0 | 0 | 0 | 0 |
| | | PLENLIZER ST210 | PBW | 0.10 | 0.10 | 0.10 | 0.10 | 0.10 | 0.10 |
| | | ANOX20 | PBW | 0 | 0 | 0 | 0 | 0 | 0 |
| | | Ultranox626 | PBW | 0 | 0 | 0 | 0 | 0 | 0 |
| | | SONGNOX 2450FF | PBW | 0.20 | 0.20 | 0.20 | 0.20 | 0.20 | 0.20 |
| | Lubricant | SC-P | PBW | 0.20 | 0.20 | 0.20 | 0.20 | 0.20 | 0.20 |
| | Water | BEN-GEL BLITE K11 | PBW | 0.40 | 0.40 | 0.40 | 0.40 | 0.40 | 0.40 |
| | absorbing | Carplex BS-304F | PBW | 0.40 | 0.40 | 0.40 | 0.40 | 0.40 | 0.40 |
| | medium | | | | | | | | |
| | Foaming agent | HFO-1234ze | PBW | 1.5 | 2.5 | 3.5 | 0.4 | 5.5 | 6.5 |
| | | Isobutane | PBW | 3.2 | 2.7 | 2.2 | 2.0 | 0 | 2.8 |
| | | Dimethyl ether | PBW | 2.5 | 2.5 | 2.5 | 3.3 | 3.0 | 1.0 |
| | | Ethyl chloride | PBW | 0 | 0 | 0 | 0 | 0 | 0 |
| | | Water | PBW | 0.7 | 0.7 | 0.7 | 0.9 | 0.9 | 0.7 |
| | Amount of | HFO-1234ze | mol | 0.11 | 0.19 | 0.26 | 0.03 | 0.40 | 0.47 |
| | foaming agent | Isobutane | mol | 0.47 | 0.39 | 0.32 | 0.29 | 0.00 | 0.40 |
| | added | Dimethyl ether | mol | 0.46 | 0.46 | 0.46 | 0.61 | 0.55 | 0.18 |
| | (Relative to 1 | Ethyl chloride | mol | 0 | 0 | 0 | 0 | 0 | 0 |
| | kg of foam) | Water | mol | 0.33 | 0.33 | 0.33 | 0.43 | 0.42 | 0.32 |
| | | Total of all foaming | mol | 1.37 | 1.36 | 1.36 | 1.37 | 1.37 | 1.37 |
| | | agents | | | | | | | |
| Production | Foaming temperature | | ° C. | 120 | 119 | 120 | 120 | 190 | 120 |
| condition | Thickness of slit die | | mm | 6 | 6 | 6 | 6 | 5 | 5 |
| | Foaming pressure | | MPa | 3.0 | 3.0 | 3.0 | 3.0 | 4.0 | 4.0 |
| Physical | Thickness of extruded styrenic resin foam | | mm | 60 | 60 | 60 | 60 | 40 | 40 |
| properties | (before cutting) | | | | | | | | |
| of | Foaming agent | HFO-1234ze | mol | 0.11 | 0.18 | 0.25 | 0.03 | 0.38 | 0.45 |
| extruded | content | Isobutane | mol | 0.44 | 0.37 | 0.30 | 0.28 | 0 | 0.38 |
| foam | (Relative to 1 | Total | mol | 0.55 | 0.55 | 0.55 | 0.31 | 0.38 | 0.83 |
| | kg of foam) | | | | | | | | |
| | Apparent density | | kg/m³ | 31 | 32 | 33 | 31 | — | — |
| | Closed cell ratio | | % | 95 | 95 | 95 | 96 | — | — |
| | Average cell diameter | | mm | 0.2 | 0.1 | 0.1 | 0.2 | 0.1 | 0.1 |
| | Cell deformation ratio | | — | 1.0 | 1.1 | 1.1 | 1.0 | — | — |
| | Thermal conductivity | | W/mK | 0.024 | 0.023 | 0.023 | 0.025 | — | — |
| | (after 7 days passed since production) | | | | | | | | |
| | Judgment on thermal conductivity | | — | Good | Good | Good | Poor | — | — |
| | JIS flammability | | | Good | Good | Poor | Good | — | — |
| | (after 7 days passed since production) | | | | | | | | |
| | Combustion spreading length | | mm | 79 | 19 | 13 | −15 | — | — |
| | (after 7 days passed since production) | | | | | | | | |
| | Appearance | Shape | — | Good | Good | Good | Good | Poor | Poor |
| | | | | | | | | Undulating | Undulating |
| | | Surface property | — | Good | Good | Good | Good | Poor | Poor |
| | | | | | | | | Crack | Crack |
| | | | | | | | | Partial | Partial |
| | | | | | | | | peeling | peeling |
| | | Judgment | — | Accepted | Accepted | Accepted | Accepted | Rejected | Rejected |

Abbreviations:
* CE1 through CE6 stand for Comparative Examples 1 through 6, respectively.
* PBW stands for parts by weight.
Annotations:
*1: The numbers within the parentheses represent the total amounts (unit: parts by weight) including the styrenic resin A or the styrenic resin. B contained in the heat ray radiation inhibitor masterbatch.
*2: The numbers within the parentheses represent addition amounts unit: parts by weight), relative to 100 parts by weight of the styrenic resin, of graphite or titanium oxide which is contained in the heat ray radiation inhibitor masterbatch.

In Comparative Example 1, (i) the amount of the saturated hydrocarbon having 3 to 5 carbon atoms contained, which is contained in the extruded styrenic resin foam 7 days after the production, is more than a desired amount and (ii) the total amount of the saturated hydrocarbon having 3 to 5 carbon atoms and the hydrofluoroolefin, which are contained in the extruded styrenic resin foam 7 days after the production, is more than a desired amount. In this case, the combustion spreading length deteriorates so much as to exceed 10 mm. As can be understood from Comparative Examples 2 and 3, the combustion spreading length deteriorates so much as to exceed 10 mm in a case where the total amount of the saturated hydrocarbon having 3 to 5 carbon atoms and the hydrofluoroolefin, which are contained in the extruded styrenic resin foam 7 days after the production, is more than a desired amount.

As can be understood from Comparative Example 4, the thermal conductivity exceeds 0.0245 W/mK so as to be judged as “rejected” in a case where the amount of hydrofluoroolefin contained in the extruded styrenic resin foam 7 days after the production is less than a desired amount.

As can be understood from Comparative Example 5, an extruded foam moldability deteriorates so as to prevent an extruded foam having a desired appearance from being achieved in a case where the amount of the saturated hydrocarbon having 3 to 5 carbon atoms contained in the extruded styrenic resin foam 7 days after the production is less than a desired amount. As can be understood from Comparative Example 6, an extruded foam moldability deteriorates so as to prevent an extruded foam having a desired appearance from being achieved in a case where the amount of the hydrofluoroolefin contained in the extruded styrenic resin foam 7 days after the production is more than a desired amount.

As can be understood from Examples 1 through 6, the extruded styrenic resin foam in accordance with one or more embodiments of the present invention may have (i) such an excellent heat insulating property that a thermal conductivity is not more than 0.0245 W/mK and (ii) such an excellent flame retardancy that a combustion spreading length is not more than 10 mm. As can be understood from Examples 1 through 6, the extruded styrenic resin foam in accordance with one or more embodiments of the present invention may be an extruded styrenic resin foam having (i) a beautiful surface and (ii) a sufficient thickness suitable for use.

In view of a heat insulating property which is indicated by a thermal conductivity, Examples 2 through 6 are preferable, and Example 6 is more preferable, out of Examples 1 through 6. A comparison between Examples 1 through 5 and Example 6 indicates that causing an extruded styrenic resin foam to contain ethyl chloride contributes to an increase in thermal conductivity of the extruded foam.

In view of a flame retardancy which is indicated by a combustion spreading length, Examples 2 through 4 and Example 6 are preferable, and Examples 3 and 4 are more preferable, out of Examples 1 through 6. A comparison between (i) Examples 1, 2, 5, and 6 and (ii) Examples 3 and 4, indicates that an amount of hydrofluoroolefin contained in an extruded styrenic resin foam contributes to an increase in flame retardancy of the extruded foam.

An extruded styrenic resin foam in accordance with one or more embodiments of the present invention may have an excellent heat insulating property and flame retardancy, a beautiful surface, and a sufficient thickness suitable for use. Therefore, it is possible to suitably use the extruded styrenic resin foam as a heat insulating material for a house or a structure.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An extruded styrenic resin foam, comprising:
100 parts by weight of a styrenic resin;
0.5 to 8.0 parts by weight of a flame retardant;
1.0 to 5.0 parts by weight of graphite;
a saturated hydrocarbon having 3 to 5 carbon atoms; and
a hydrofluoroolefin,
wherein 1 kg of the extruded styrenic resin foam comprises:
the hydrofluoroolefin in an amount of 0.05 to 0.40 mol; and
the saturated hydrocarbon in an amount of 0.10 to 0.40 mol, a total amount of the saturated hydrocarbon and the hydrofluoroolefin being 0.30 to 0.50 mol relative to 1 kg of the extruded styrenic resin foam.

2. The extruded styrenic resin according to claim 1, wherein:
the extruded styrenic resin foam has a flame retardancy that satisfies JIS A9521, as measured by method A specified in JIS A9521; and
the extruded styrenic resin foam has a combustion spreading length of not more than 10 mm.

3. The extruded styrenic resin foam according to claim 1, wherein the extruded styrenic resin foam has an apparent density of 20 to 45 kg/m³ and a closed cell ratio of not less than 90%.

4. The extruded styrenic resin foam according to claim 1, further comprising at least one foaming agent selected from the group consisting of dimethyl ether, ethyl chloride, and methyl chloride,
wherein the extruded styrenic resin foam is produced by
heating a mixture comprising the styrenic resin, the flame retardant, and the graphite,
adding the saturated hydrocarbon, the hydrofluoroolefin, and 0.5 to 15 parts by weight of the at least one foaming agent to the mixture, and
extruding the mixture.

5. The extruded styrenic resin foam according to claim 1, wherein the saturated hydrocarbon is isobutane.

6. The extruded styrenic resin foam according to claim 1, wherein the hydrofluoroolefin is a tetrafluoropropene.

7. The extruded styrenic resin foam according to claim 1, wherein the extruded styrenic resin foam has a thickness of 10 to 150 mm.

8. The extruded styrenic resin foam according to claim 1, wherein
the flame retardant is a bromine flame retardant; and
the bromine flame retardant is contained in an amount of 0.5 to 5.0 parts by weight.

9. A method for producing an extruded styrenic resin foam, comprising:
heating a mixture comprising:
100 parts by weight of a styrenic resin,
0.5 to 8.0 parts by weight of a flame retardant, and
1.0 to 5.0 parts by weight of graphite;
adding a saturated hydrocarbon having 3 to 5 carbon atoms and a hydrofluoroolefin to the mixture; and
extruding the mixture,
wherein 1 kg of the extruded styrenic resin foam comprises:
the hydrofluoroolefin in an amount of 0.05 to 0.40 mol; and
the saturated hydrocarbon in an amount of 0.10 to 0.40 mol.

10. The method according to claim 9, further comprising adding to the mixture 0.5 to 15 parts by weight of at least one foaming agent selected from the group consisting of dimethyl ether, ethyl chloride, and methyl chloride.
